(19) United States
(12) Patent Application Publication
(10) Pub. No.: US 2012/0291068 A1
(43) Pub. Date: Nov. 15, 2012

(54) HOME DEVICE CONTROL ON TELEVISION

(75) Inventors: Rahul Khushoo, Waltham, MA (US); Ravi Potluri, Irving, TX (US); Sanjay Vyas, Hyderabad (IN); Hong Xiao, Acton, MA (US)

(73) Assignee: VERIZON PATENT AND LICENSING INC., Basking Ridge, NJ (US)

(21) Appl. No.: 13/103,466

(22) Filed: May 9, 2011

(51) Int. Cl. H04N 5/445; H04N 7/16

(52) U.S. Cl. 725/38; 725/139

(57) ABSTRACT

A set-top box may present video content on a television and receive a user request to present an interactive home controls application on the television. Based on the user request, the set-top box may retrieve information associated with one of multiple home devices, and may generate, based on the home device information, an interactive home controls frame that includes functional tiles for managing the home devices. At least one of the functional tiles may include information associated with the one of the multiple home devices and options to control the one of the multiple devices. The set-top box may simultaneously present to the user the interactive home controls frame, including at least one of the functional tiles, and the video content on the television.

### BACKGROUND

Most homes have numerous home devices, such as electrical systems (e.g., light switches, radios, etc.), mechanical systems (e.g., windows, doors, door locks, etc.), communication systems (e.g., a security system, a local area network (LAN), etc.), and entertainment systems (e.g., televisions, home theater systems, etc.). A smart home (or connected home) brings all of these home devices together. By wiring controls of each home device to one point, commonly known as a control system overlay or control point, the home devices can be integrated and made interoperable. Such smart home automation technologies are commercially available. However, limited service scalability, complexity of configuration, interoperability problems of different hardware and software components (e.g., of home devices), and excessive cost have prevented mass adoption of smart home automation technologies.

### BRIEF DESCRIPTION OF THE DRAWINGS

FIG. 1 is a diagram of an exemplary network in which systems and/or methods described herein may be implemented;

FIG. 2 is a diagram of exemplary components of one or more devices of the network depicted in FIG. 1;

FIG. 3 depicts exemplary components of a remote control of the network depicted in FIG. 1;

FIG. 4 is an exemplary environment for navigating an on-screen display with a device control dashboard capable of being generated by a set-top box (STB) of FIG. 1;

FIGS. 5A-5D provide exemplary user interfaces for an active security camera tile capable of being generated by the STB of FIG. 1;

FIG. 6 is a diagram of exemplary operations capable of being performed by an exemplary portion of the network illustrated in FIG. 1 to provide live video for the user interface of FIG. 5C;

FIG. 7 is a diagram of exemplary operations capable of being performed by an exemplary portion of the network illustrated in FIG. 1 to provide live video for the user interfaces of FIGS. 5A and 5B;

FIGS. 8A-8B are diagrams of exemplary user interfaces for an active devices tile capable of being generated by the STB of FIG. 1;

FIGS. 9A-9C are diagrams of exemplary user interfaces for an active energy tile capable of being generated by the STB of FIG. 1;

FIGS. 10A-10C are diagrams of exemplary user interfaces for an active thermostat tile capable of being generated by the STB of FIG. 1;

FIGS. 11A-11B are diagrams of exemplary user interfaces for an active modes tile capable of being generated by the STB of FIG. 1;

FIGS. 12A and 12B are diagrams of exemplary user interfaces for an active notifications tile capable of being generated by the STB of FIG. 1;

FIG. 13 is a diagram of other exemplary user interface for a notification tile capable of being generated by the STB of FIG. 1;

FIG. 14 is a diagram of other exemplary operations capable of being performed by an exemplary portion of the network illustrated in FIG. 1;

FIG. 15 is a flow chart of an exemplary process for providing smart home device management via a television interface according to implementations described herein; and

FIG. 16 is a flow chart of another exemplary process for providing smart home device management via a television interface according to implementations described herein.

### DETAILED DESCRIPTION OF PREFERRED EMBODIMENTS

The following detailed description refers to the accompanying drawings. The same reference numbers in different drawings may identify the same or similar elements.

Systems and/or methods described herein may enable management of home devices (e.g., lights, security systems, electronics, video surveillance, energy systems, monitoring systems, etc.) via a television interface with a remote control. For example, the systems and/or methods may enable a user of a television to receive an overview of the home devices in an interactive user interface displayed on the television. The interactive user interface may incorporate a stage-based interface that includes separate graphical window (or “tiles”) that can be presented to the user by sliding each tile onto a display area presented on the television. The user may shift to a particular category of home devices controls, control the home devices, and/or retrieve information about the devices while maintaining presentation of another video feed, such as a live television feed, a pay-per-view feed, etc.

In one exemplary implementation, the systems and/or methods may present video content (e.g., a television program) on a television and receive a user request to present an interactive home controls application on the television. The systems and/or methods may retrieve, based on the user request, information associated with one of multiple home devices, and may generate, based on the home device information, an interactive home controls frame that includes functional tiles for managing the home devices. At least one of the functional tiles may include information associated with the particular one of the multiple home devices and options to control the one of the multiple devices. The systems and/or methods may simultaneously present to the user the interactive home controls frame, including at least one of the functional tiles, and the video content on the television.

As used herein, the term “interactive television application” may refer to an application that may receive and respond to user input (e.g., via a remote control or control buttons on a set-top box (STB)). In some cases, interactive television applications may also be referred to as “widgets.”

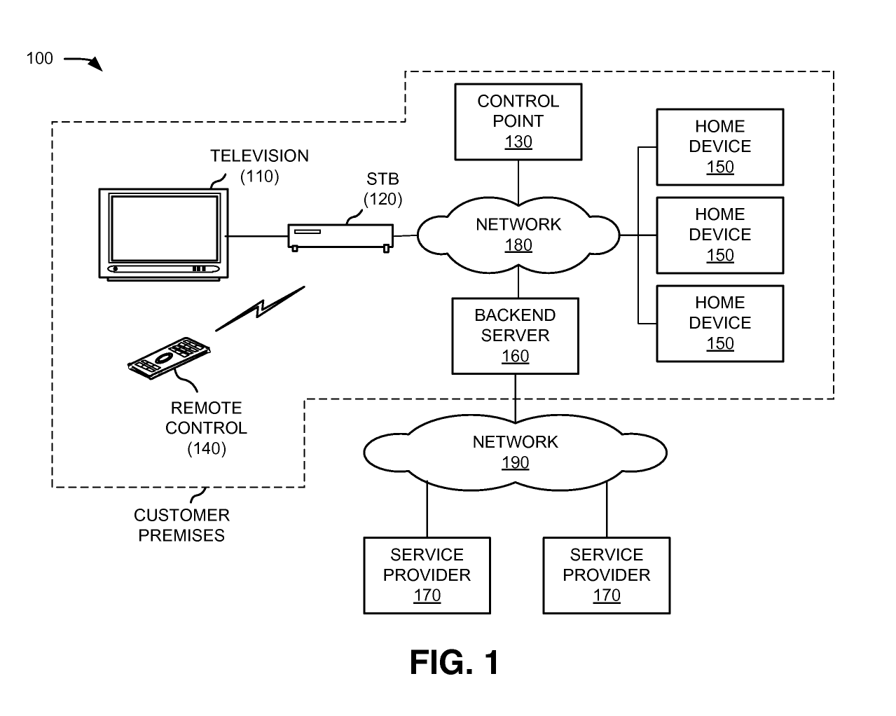

FIG. 1 is a diagram of an exemplary network 100 in which systems and/or methods described herein may be implemented. As illustrated, network 100 may include a television 110, a STB 120, a control point 130, a remote control 140, home devices 150, a backend server 160, and service providers 170 interconnected by networks 180/190. Components of network 100 may interconnect via wired and/or wireless connections. One television 110, one STB 120, one control point 130, one remote control 140, three home devices 150, one backend server 160, two service providers 170, and two networks 180/190 have been illustrated in FIG. 1 for simplicity. In practice, there may be more televisions 110, STBs 120, control points 130, remote controls 140, home devices 150, backend servers 160, service providers 170 and/or networks 180/190. Also, in some instances, one or more of the components of network 100 may perform one or more functions described as being performed by another one or more of the components of network 100.

Television 110 may include any digital or analog display that is capable of displaying television programming, content provided by STB 120, and/or content provided by other devices (e.g., a digital video disk (DVD) player, a video camera, a digital video recorder (DVR), an Internet connection, etc., not shown) connected to television 110. Television 110 may include technologies, such as liquid crystal displays (LCDs), light-emitting diode (LED) displays, cathode ray tube (CRT) displays, plasma displays, etc.

STB 120 may include a device for selecting, generating, and/or obtaining (e.g., from control point 130, backend server 160, and/or service provider 170) content that may be shown or played on television 110 or another device. STB 120 may allow a user to alter the programming provided to television 110 based on a signal (e.g., a channel up or channel down signal, a function signal, a navigation signal, etc.) from remote control 140. STB 120 may receive a television (or other programming) signal from service provider 170 (e.g., via networks 180/190), may convert the signal to a form usable by television 110, and may transmit the signal to television 110 for display. In one implementation, STB 120 may be configured to support particular video formats, such as Moving Picture Experts Group (MPEG)-2. Additionally, or alternatively, STB 120 may include two or more tuners to simultaneously receive and/or present multiple television programs (e.g., a picture-in-picture display).

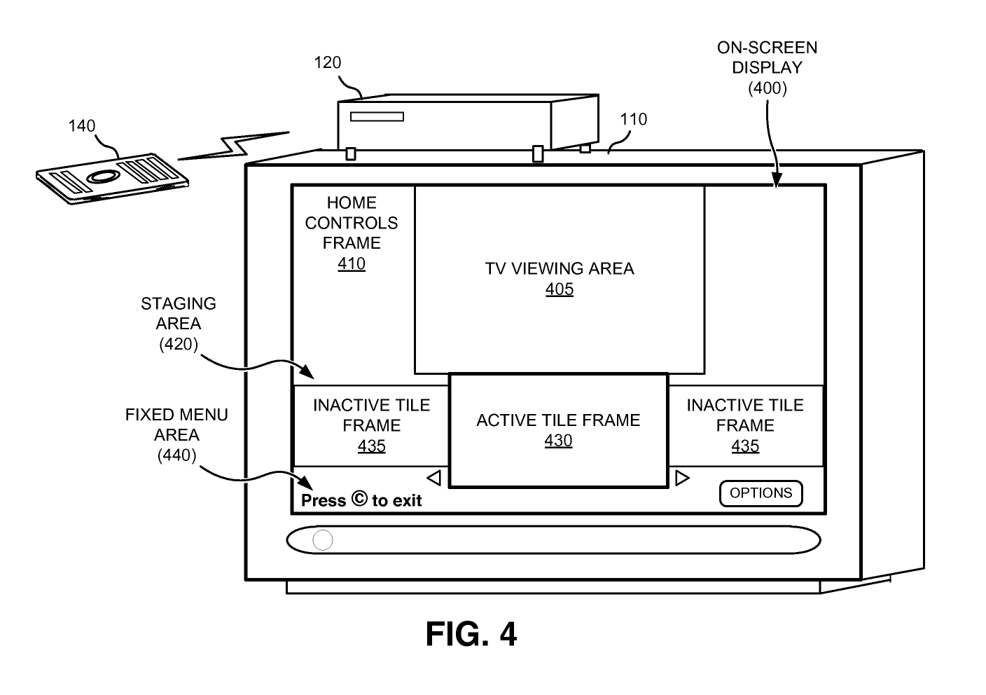

In implementations described herein, STB 120 may employ an interactive television application platform to control home smart appliances (e.g., devices 150) while also presenting television programming. For example, STB 120 may present, on television 110, a device control dashboard with an interactive menu that allows a user to provide input via a remote control, such as remote control 140. In an exemplary implementation, the device control dashboard may be opened via an on-screen “widget” that can be selectively activated by the viewer. In other implementations, the device control dashboard may be selected from an interactive menu or via a dedicated button on remote control 140. The device control dashboard is described further in connection with, for example, FIGS. 4-12. STB 120 may support interactive interfaces using Enhanced TV Binary Interchange Format (EBIF) or another interactive television format.

Control point 130 may include one or more computing devices, or other types of computation or communication devices, that gather, process, search, and/or provide information in a manner described herein. In one implementation, control point 130 may receive status information from home devices 150 and supply the information to STB 120 for inclusion in the device control dashboard. Control point 130 may also receive command signals from STB 120 (e.g., based on user input via remote control 140) and provide command signals to control home devices 150. Control point 130 may receive, from STB 120, a request to control a particular home device 150, and may provide the control request to the particular home device 150 for implementing. For example, if the particular home device 150 is a light switch, the control request may include turning the light switch off. Control point 130 may provide the control request to the light switch, and the light switch may turn itself off. Control point 130 may receive updated home device information based on implementation of the control request (e.g., the updated home device information may indicate that the light switch is turned off), and may provide the updated home device information to STB 120. Additionally, or alternatively, control point 130 may convert and/or transcode signals (e.g., still image and/or video signals) from user devices 150 to enable presentation by STB 120 on television 110.

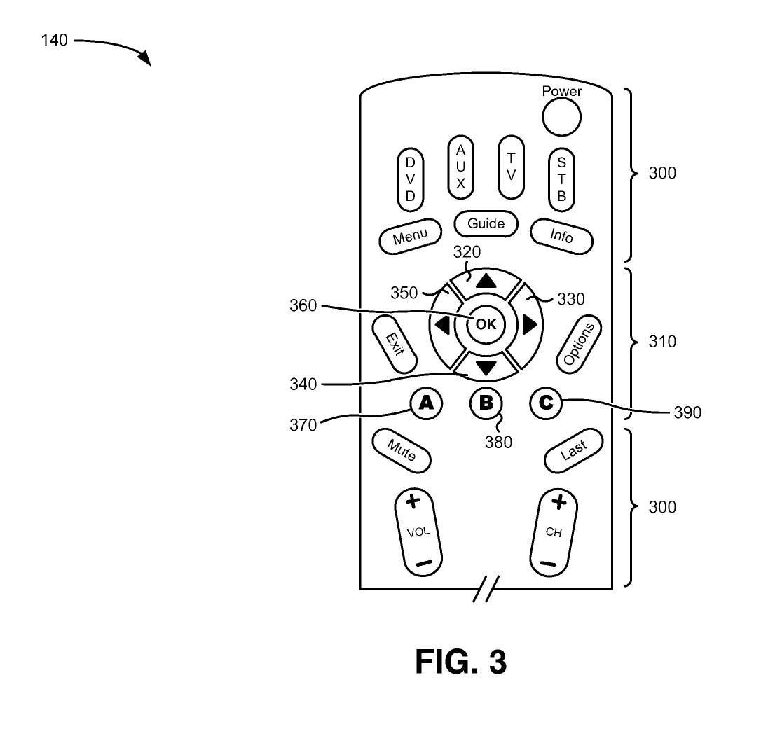

Remote control 140 may include a device that allows a user to control programming and/or content displayed on television 110 via interaction with STB 120. Remote control 140 may transmit signals, such as, for example, infrared signals, to a signal receiver associated with television 110 and/or STB 120. Remote control 140 is described further in connection with, for example, FIG. 3.

Home devices 150 may include any device capable of providing information associated with a home (or another area to be controlled), any device (e.g., provided in a home or another area) that is capable of being controlled, etc. For example, home devices 150 may include devices provided in electrical systems (e.g., light switches, lights, televisions, radios, etc.), devices provided in mechanical systems (e.g., windows, blinds, doors, door locks, etc.), devices provided in communication systems (e.g., security system devices, surveillance cameras, LAN devices, routers, modems, etc.), devices provided in entertainment systems (e.g., home theater systems, stereos, etc.), etc.

Backend server 160 may include one or more server devices, or other types of computation or communication devices, that gather, process, search, and/or provide information in a manner described herein. Backend server 160 may include configuration information, such as device names, IP addresses, status, and settings, for home devices 150. In one implementation, backend server 160 may provide configuration information to STB 120 to enable STB 120 to request information and/or facilitate commands from control point 130 to particular home devices 150. In one implementation, control point 130 and backend server 160 may be combined in a single device.

Service providers 170 may include one or more server devices, or other types of computation or communication devices, that gather, process, search, and/or provide information in a manner described herein. In one example, service provider 170 may include a computer system, an application, a cable head-end, a broadcasting device, a mobile communications system, etc. capable of providing information to STB 120. For example, service providers 170 may include video content providers (e.g., television providers, video-on-demand (VOD) providers, over-the-top (OTT) content providers, etc.), Internet service providers, smart home providers, etc. In one exemplary implementation, service provider 170 may receive home device information from home devices 150, and may provide home device information to backend server 160. In another exemplary implementation, service provider 170 may receive (e.g., from backend server 160) requests to control home devices 150, and may provide the requests to home devices 150 (e.g., for implementation by home devices 150).

Networks 180/190 may include a LAN, a wide area network (WAN), a metropolitan area network (MAN), a telephone network, such as the Public Switched Telephone Network (PSTN), a cellular network, a Wi-Fi network, an intranet, the Internet, an optical fiber (or fiber optic)-based network, or a combination of networks. Devices using networks 180/190 may be connected via wired (e.g., Ethernet, coaxial cable, etc.) or wireless connections (e.g., using network devices such as those available under the IEEE 802.11 wireless LAN standards). Network 180 may be located within a customer premises, while network 190 may connect devices in the customer premises to external devices, such as service providers 170.

As an example of network 100 operations, a user may control STB 120 to receive television programming, from one of service providers 170, that may be presented on television 110. Additionally, a user may use remote control 140 to activate a device control dashboard to monitor/change settings for home devices 150. STB 120 may receive information associated with home devices 150, and may present to a user (via television 110) the device control dashboard that includes a stage of selectable tiles, such as a notifications tile, a security camera tile, a home device tile, an energy tile, a thermostat tile, and a modes tile. Information from home devices 150 may generally include any information capable of being generated by home devices 150. For example, if home device 150 is a thermostat, home device information for the thermostat may include a temperature recorded by the thermostat, a desired (or set) temperature for an area of the home, controls for the thermostat (e.g., an up arrow to increase a set temperature, a down arrow to decrease a set temperature, etc.), etc. In another example, if home device 150 is a security camera, home device information may include video captured by the security camera, images captured by the security camera, controls for the security camera (e.g., mechanisms to control movement of the surveillance camera, to control zooming of the surveillance camera, etc.), etc.

As described further herein, a user may select a particular tile from the stage of selectable tiles, and STB 120 may display, on television 110, home device information corresponding to the selected tile. The user may use the selected tile to view information about one or more of home devices 150, provide commands to control home devices 150, and/or control the presentation of additional home device information.

Although FIG. 1 shows exemplary components of network 100, in other implementations, network 100 may contain fewer components, different components, differently arranged components, or additional components than depicted in FIG. 1.

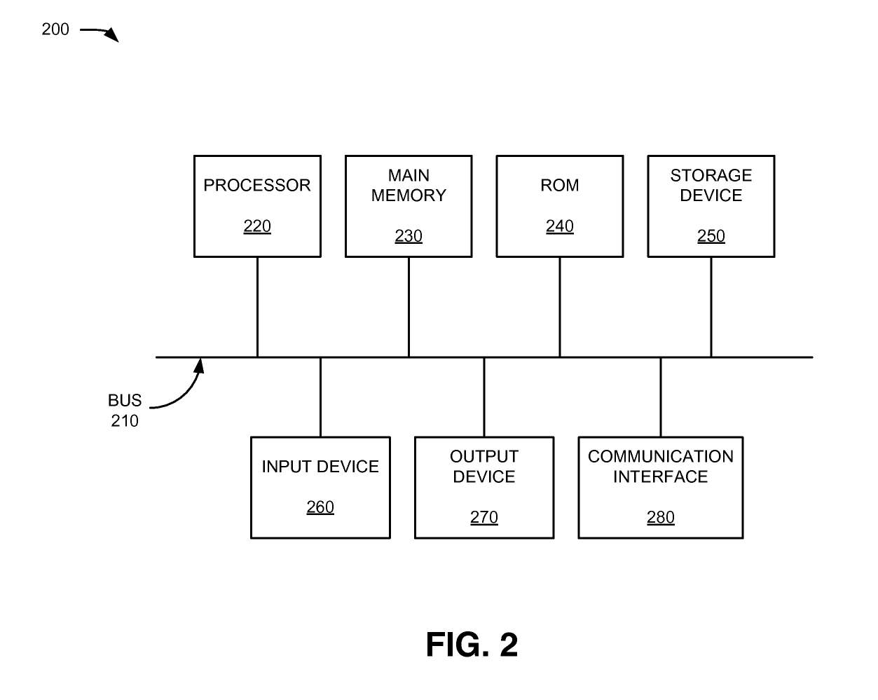

FIG. 2 is a diagram of exemplary components of a device 200 that may correspond to one or more devices of network 100, such as STB 120, control point 130, backend server 160, or service provider 170. As illustrated, device 200 may include a bus 210, a processor 220, a main memory 230, a read-only memory (ROM) 240, a storage device 250, an input device 260, an output device 270, and a communication interface 280. Bus 210 may include a path that permits communication among the components of device 200.

Processor 220 may include one or more processors, microprocessors, or other types of processing units that may interpret and execute instructions. Main memory 230 may include a random access memory (RAM) or another type of dynamic storage device that may store information and instructions for execution by processor 220. ROM 240 may include a ROM device or another type of static storage device that may store static information and/or instructions for use by processor 220. Storage device 250 may include a magnetic and/or optical recording medium and its corresponding drive.

Input device 260 may include a mechanism that permits an operator to input information to device 200, such as remote control 140, control buttons, a keyboard, a mouse, a pen, a microphone, voice recognition and/or biometric mechanisms, a touch screen, etc. Output device 270 may include a mechanism that outputs information to the operator, including a display, an indicator light, a speaker, etc. Communication interface 280 may include any transceiver-like mechanism that enables device 200 to communicate with other devices and/or systems. For example, communication interface 280 may include mechanisms for communicating with another device or system via a network.

As described herein, device 200 may perform certain operations in response to processor 220 executing software instructions contained in a computer-readable medium, such as main memory 230. A computer-readable medium may be defined as a non-transitory memory device. A memory device may include space within a single physical memory device or spread across multiple physical memory devices. The software instructions may be read into main memory 230 from another computer-readable medium, such as storage device 250, or from another device via communication interface 280. The software instructions contained in main memory 230 may cause processor 220 to perform processes described herein. Alternatively, hardwired circuitry may be used in place of or in combination with software instructions to implement processes described herein. Thus, implementations described herein are not limited to any specific combination of hardware circuitry and software.

Although FIG. 2 shows exemplary components of device 200, in other implementations, device 200 may contain fewer components, different components, differently arranged components, or additional components than depicted in FIG. 2. In still other implementations, one or more components of device 200 may perform one or more other tasks described as being performed by one or more other components of device 200.

FIG. 3 depicts exemplary components of remote control 140. As shown, remote control 140 may include a first set 300 of control buttons and a second set 310 of control buttons. Although FIG. 3 shows control buttons associated with remote control 140, in other implementations, remote control 140 may include a touch screen display (or other input mechanisms) and may omit some or all of control buttons 300/310. The touch screen display may be configured to display images of control buttons (e.g., similar to the control buttons provided in FIG. 3) and to receive a user input when the user touches the touch screen display. For example, the user may provide an input to the touch screen display directly, such as via the user's finger, or via other input objects, such as a stylus. User inputs received via the touch screen display may be processed by components and/or devices operating in remote control 140. The touch screen display may permit the user to interact with remote control 140 in order to cause remote control 140 to perform one or more operations.

First set 300 of control buttons may include one or more control buttons that cause remote control 140 to perform one or more operations. For example, first set 300 of control buttons may cause remote control 140 to transmit one or more signals (e.g., to STB 120) representative of the one or more operations. As shown in FIG. 3, first set 300 of control buttons may include a power button (e.g., to cause remote control 140 to transmit a signal instructing STB 120 to power on or power off); a digital video recorder (DVD) button (e.g., to cause remote control 140 to transmit a signal instructing a DVD player (not shown) to perform an operation); an auxiliary (AUX) button (e.g., to cause remote control 140 to transmit a signal instructing an auxiliary device (e.g., a stereo) to perform an operation); a TV button (e.g., to cause remote control 140 to transmit a signal instructing television 110 to perform an operation); and a STB button (e.g., to cause remote control 140 to transmit a signal instructing STB 120 to perform an operation).

As further shown in FIG. 3, first set 300 of control buttons may also include a menu button, a guide button, and an information (Info) button. The menu button, when selected by a user, may cause remote control 140 to transmit a signal instructing STB 120 to display (e.g., on television 110) a television menu (e.g., a menu that provides access to features associated with a subscription multimedia service). The guide button may cause remote control 140 to transmit a signal instructing STB 120 to display (e.g., on television 110) a television guide (e.g., an interactive programming guide, a listing of all available television channels, etc.). The information button may cause remote control 140 to transmit a signal instructing STB 120 to display (e.g., on television 110) information about currently displayed television content. In another implementation, first set 300 of control buttons may additionally, or alternatively, include a home controls button (not shown) that may cause remote control 140 to transmit a signal instructing STB 120 to display (e.g., on television 110) an interactive home controls frame. First set 300 of control buttons may also include a channel button (e.g., with an up channel portion and a down channel portion) and a volume button (e.g., with an up volume portion and a down volume portion).

Second set 310 of control buttons may include one or more adaptable control buttons that cause remote control 140 to perform one or more operations. For example, second set 310 of control buttons may cause remote control 140 to transmit a first set of signals (e.g., to STB 120) when in a first mode, and to transmit a second set of signals (e.g., to STB 120) when in a second mode. In some implementations, second set of control buttons may have other modes (e.g., a third mode, a fourth mode, a fifth mode, etc.). As shown in FIG. 3, second set 310 of control buttons may include four directional buttons 320, 330, 340 and 350; an OK button 360; and three multifunction buttons A 370, B 380, and C 390. In one implementation multifunction buttons A 370, B 380, and C 390 may conform to standards for the OpenCable Application Platform (OCAP).

Some or all of buttons 320-390 may provide signals that may be adapted depending on a mode identified by remote control 140. For example, in a first, or default, mode, buttons 320-390 may perform various functions for television viewing and program selection. Directional buttons 320-350 may permit a user (e.g., via remote control 140) to navigate through a menu output by STB 120 (e.g., via television 110). OK button 360 may permit a user (e.g., via remote control 140) to select an item of a menu output by STB 120 (e.g., via television 110). Multifunction buttons A 370, B 380, and C 390 may perform functions such as a “favorites” button, a “features” and an “on demand” button when in a first mode.

In a second mode, buttons 320-390 may perform various functions for providing input to, for example, an interactive television application, such as an interactive television application platform to control home smart appliances (e.g., home devices 150). For example, directional buttons 320-350 may provide signals to modify a feature of the interactive television application without affecting an underlying program (e.g., television program), such as altering an active tile of the interactive television application, changing settings within an active tile, etc. Similarly, buttons 370-390 may be associated with particular functions related to the interactive television application.

Although FIG. 3 shows exemplary components of remote control 140, in other implementations, remote control 140 may contain fewer components, different components, differently arranged components, and/or additional components than depicted in FIG. 3. For example, remote control 140 may include addition buttons on a back or side surface that may be grouped with first set 300 of control buttons or second set 310 of control buttons. In still other implementations, one or more components of remote control 140 may perform one or more other tasks described as being performed by one or more other components of remote control 140.

FIG. 4 is a diagram of an exemplary environment for navigating an on-screen display 400 with a device control dashboard capable of being generated by STB 120. In one implementation, on-screen display 400 may be configured by STB 120 and presented on television 110.

As shown in FIG. 4, on-screen display 400 may be presented to a user on television 110. On-screen display 400 may include a television viewing area 405 and a home controls frame 410. Home controls frame 410 may include a staging area 420, which may display an active tile frame 430, and a fixed menu area 440. As shown in the example of FIG. 4, staging area 420 may also include multiple inactive tile frames 435.

Television viewing area 405 may include an area to present video content and related information for general television viewing. For example, television viewing area 405 may include video content, such as actual programming selected by the user, such as a broadcast television program, pay-per-view (PPV) content, streaming video, or other video content. Television viewing area 405 may also include tuning information, such as a channel number, network name, and/or program name for a particular program selected by a user. Television viewing area 405 may be adjustable and proportionately sized fit an available/assigned area. For example, television viewing area 405 may consume the entire area of on-screen display 400 when no additional information (e.g., such as home control frame 410) is being displayed.

Home controls frame 410 may generally include presentation of an interactive application to provide a home device control dashboard. In one implementation, home controls frame 410 may be selectively toggled on/off by a user using remote control 140. For example, home controls frame 410 may be launched/closed by using a dedicated key on remote control 140 (e.g., one of first set 300 of control buttons). In another implementation, home controls frame may be selected from a menu (e.g., a menu of interactive application items available from STB 120). When home controls frame 410 is off, television viewing area 405 may fill the entire on-screen display 400. When home controls frame 410 is enabled, home control frame 410 may fill a portion of on-screen display 400 and the size of television viewing area 405 may be proportionally reduced.

Staging area 420 may include a graphical user interface (GUI) to selectively present active tile frame 430 and inactive tile frames 435. Each of active tile frame 430 and inactive tile frames 435 may present a graphical function tile (or window) for a dedicated topic or function (e.g., related to control of home devices 150). Each inactive tile frame 435 may present a functional tile with current home device information that can be viewed, but not controlled, by the user. A particular tile may be activated by selectively positioning the tile in active tile frame 430 of staging area 420. For example, selectable function tiles may include a security camera tile, a devices tile, an energy tile, a thermostat tile, a modes tile, a notifications tile, and an activity log tile.

In one implementation, STB 120 may receive information associated with home devices 150, and may display in staging area 420 some or all of the selectable tiles, such as a security camera tile, a devices tile, an energy tile, a thermostat tile, a modes tile, or a notifications tile. Each tile in staging area 420 may present display elements (e.g., keys, icons, buttons, links, etc.), command options, and/or information that may be unrelated to the other tiles. A user may select a particular tile via a navigation signal (e.g., a left/right arrow, such as (e.g., directional buttons 330/350) on remote control 140 to position (or “slide”) the particular tile into active tile frame 430. In one implementation, only a tile and associated functions positioned within active tile frame 430 of staging area 420 may receive commands from remote control 140.

For example, if the notifications tile is selected, STB 120 may cause television 110 to display notifications and command options associated with home devices 150 (e.g., a notification that a particular device has changed status). If the security camera tile is selected STB 120 may cause television 110 to display information and command options for audio and/or visual home devices 150 (e.g., cameras). If the home device tile is selected, STB 120 may cause television 110 to display home device information (e.g., a current status of each home device 150) and command options. If the energy tile is selected, STB 120 may cause television 110 to display information associated with home energy consumption (e.g., an indication of daily/monthly energy use) and command options. If the thermostat tile is selected, STB 120 may cause television 110 to present temperature control settings for a particular control zone and thermostat command options. If the modes tile is selected, STB 120 may cause television 110 to display information associated with modes of home devices 150 (e.g., in a “morning mode,” a security system may be disabled, lights may be turned on, doors may be unlocked, etc.) and modes command options.

Fixed menu area 440 may include selection mechanisms and/or instructions for commands that may be used generally for home controls frame 410. For example, fixed menu area 440 may include general commands that relate to the interactive television application platform to control home smart appliances regardless of what tile is positioned within active tile fame 430 of staging area 420. General commands may include closing home controls frame 410, presenting an options menu (e.g., to configure home controls frame 410, settings associated with particular tiles, etc.), etc. As shown in FIG. 4, selection mechanisms for fixed area menu 440 may include, for example, instructions for multifunction keys (e.g., one of multifunction keys 370-390) of remote control 140 or a button/icon that may be navigated to via directional keys (e.g., directional buttons 320-350) of remote control 140.

Although on-screen display 400 depicts a variety of information, in other implementations, on-screen display 400 may depict less information, additional information, different information, or differently arranged information than depicted in FIG. 4.

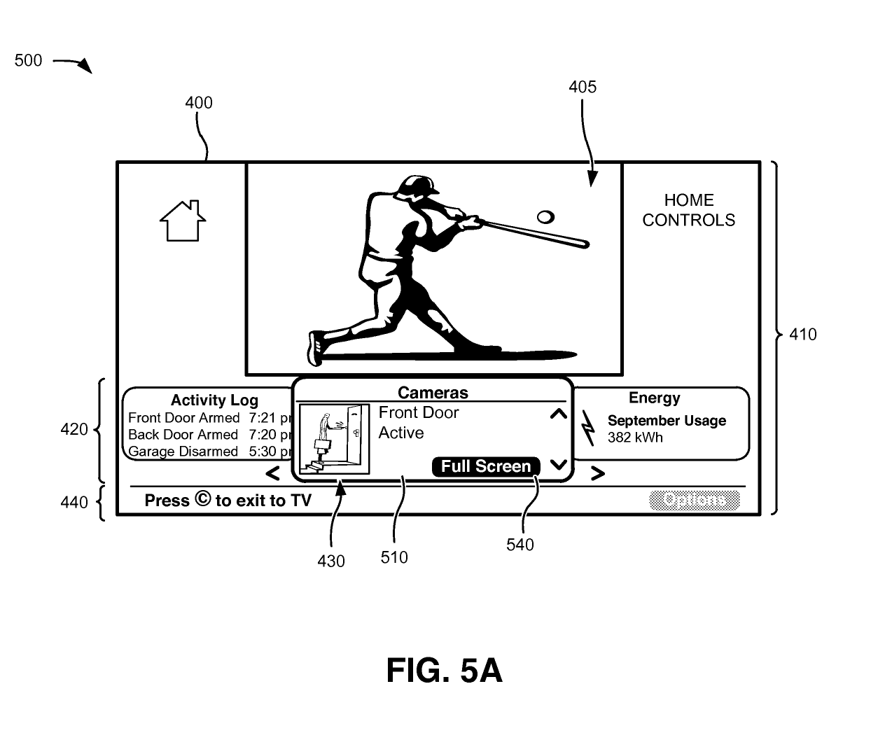

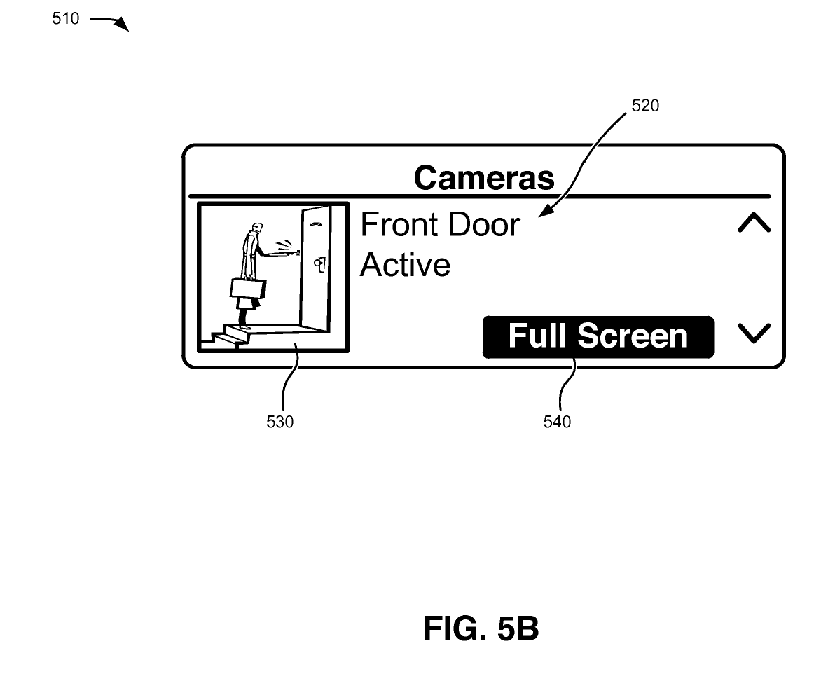

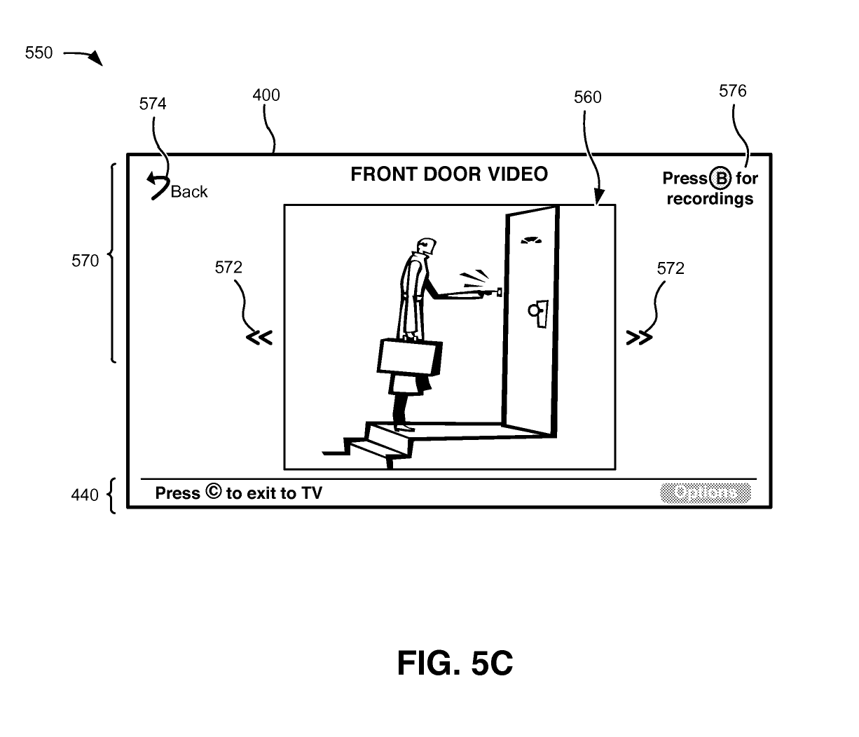

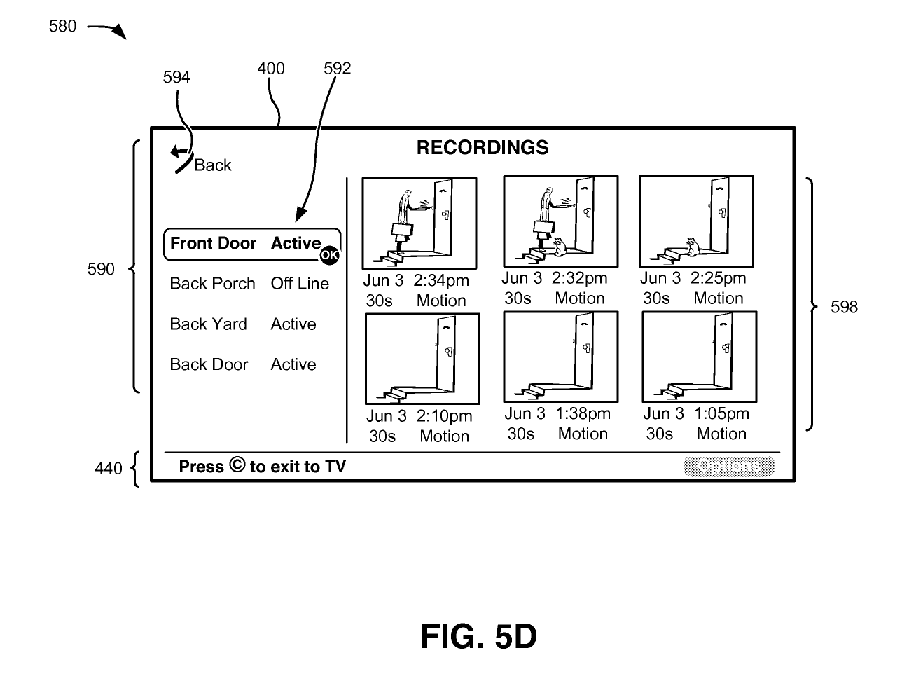

FIGS. 5A-5D provide exemplary user interfaces 500 associated with an active security camera tile 510. As shown in FIG. 5A, to view/control security camera functions, a user may use remote control 140 to position security camera tile 510 in the active tile frame 430 of staging area 420 within home controls frame 410. FIG. 5B provides an enlarged view of security camera tile 510.

Security camera tile 510 may include a list of available security camera entries 520 (e.g., of home devices 150) and a thumbnail image 530 associated with each available security camera entry 520. Security camera entry 520 may include, for example, a name/location of a particular camera (e.g., “Front Door”) and a status (e.g., “Active” or “Off Line”) associated with the security camera entry 520. The viewable size of the list of security cameras entries 520 and thumbnails 530 may be limited to a small number of entries (e.g., one or two) that can be accommodated with visual clarity in the size of active tile frame 430/security camera tile 510. However, the list of security cameras may include additional security cameras entries 520 and thumbnails 530 that may be viewed, for example, by using vertical scrolling commands (e.g., an up/down arrow on remote control 140, not shown). Security camera tile 510 may also include a camera selection mechanism 540 (e.g., an icon, button, highlight, or another graphical representation) that may allow selection of a particular security camera entry 520.

In the configuration shown in FIG. 5A, security camera tile 510 may generally receive navigation/command signals from remote control 140 that include vertical indicators (e.g., up arrow 320/down arrow 340) and/or multipurpose function keys (e.g., OK button 360, “A,” “B,” etc.). Horizontal indicators (e.g., right arrow 330/left arrow 350) may be used to slide security camera tile 510 out of active frame tile 430 in stage area 420. In another implementation, other navigational orientations may be used. For example, horizontal indicators may be used to navigate within the active tile, while vertical indicators may be used to navigate between functional tiles.

In one implementation, selection of a particular security camera entry 520 (e.g., via OK button 360 on remote control 140) may cause STB 120 to provide user interfaces that display additional information for a security camera (e.g., one of home devices 150) associated with security camera entry 520. These additional user interfaces may, for example, activate full-screen camera control interfaces. For example, if the user selects camera selection mechanism 540 (e.g., “full screen”) of user interface 500 (FIG. 5B), a user interface 550 (depicted in FIG. 5C), that corresponds to the selected security camera entry 520, may be presented to the user. As shown in FIG. 5C, user interface 550 may include a live video section 560 and a navigation section 570.

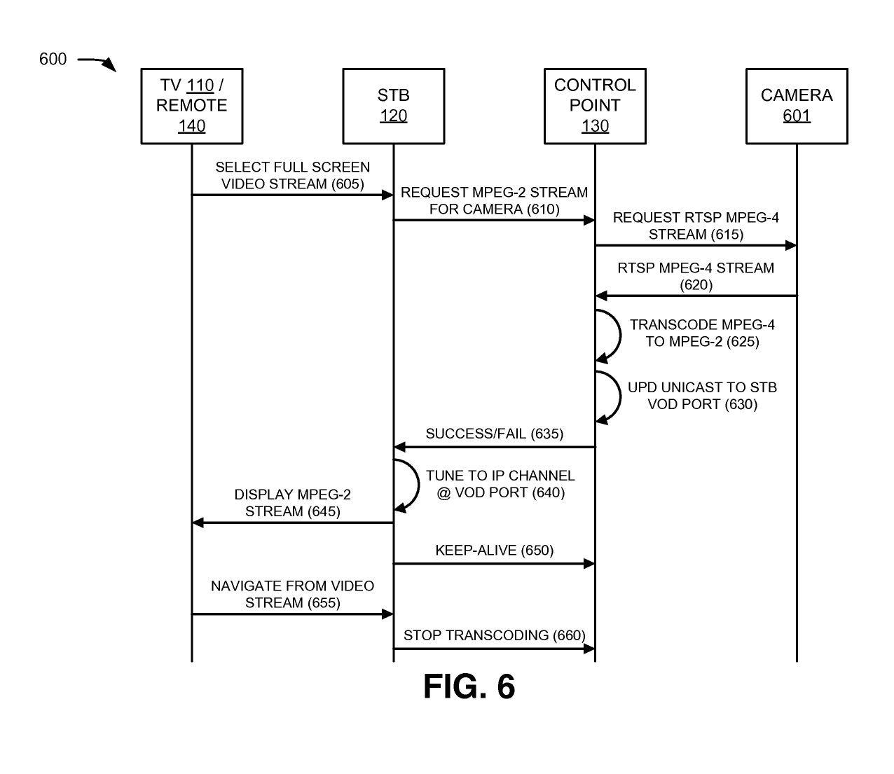

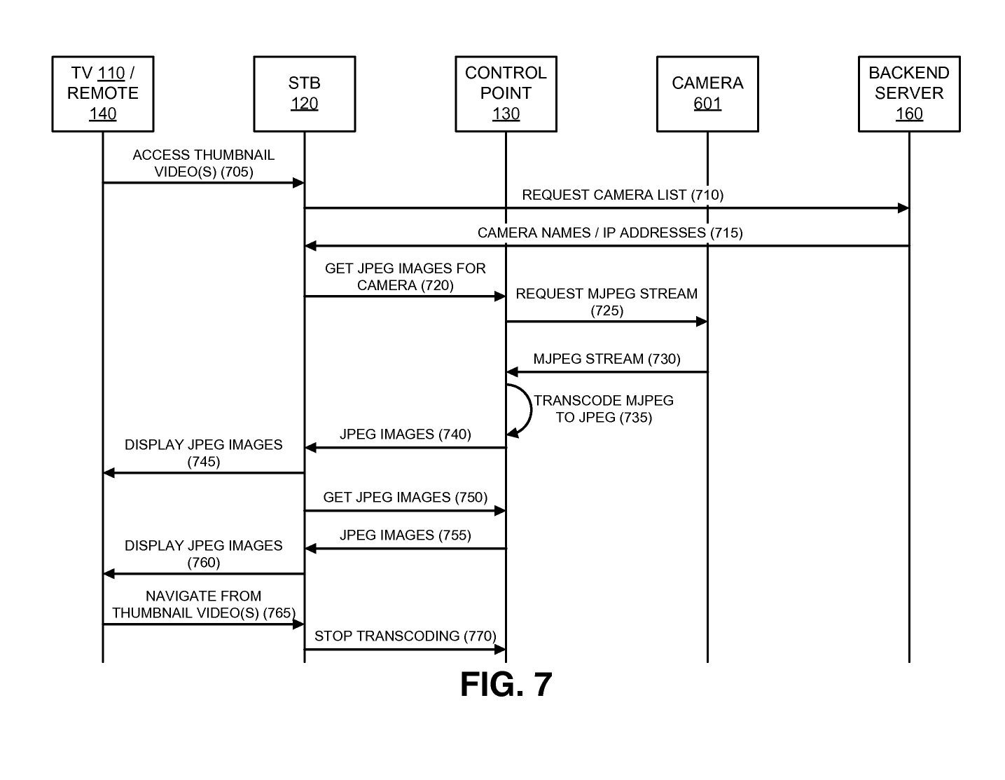

Live video section 560 may include video information received from the camera being viewed or controlled (e.g., the camera located at the front door). For example, video section 560 may include a larger-sized version of video thumbnail 530 associated with the selected security camera entry 520. While video thumbnail 530 may include a relatively lower bit-rate intensive format (e.g., Joint Photographic Experts Group (JPEG) frames extracted from Motion-JPEG video format), live video section 560 may present a higher-resolution video image (e.g., MPEG-2 format). Camera information flows to STB 120 are described further below in connection with FIGS. 6 and 7.

Navigation section 570 may include selections that may permit different views and/or controls associated with security cameras. For example, navigation section 570 may include a camera selection mechanism 572, a return mechanism 574, and a recordings access mechanism 576. Camera selection mechanism 572 may include a selection mechanism (e.g., an icon, a button, list, another graphical representation, or instructions to use a specific function key) that, when selected, may cause live video section to present live video images from another camera (e.g., of home devices 150). For example, if home devices 150 include a front door camera, a back porch camera, a back yard camera, and a back door camera, a user may use camera selection mechanism 572 to toggle among images from each camera. Return mechanism 574 may include a selection mechanism that may cause STB 120 to return to a previous user interface screen (e.g., user interface 500).

Recordings access mechanism 576 may include a selection mechanism (e.g., an icon, a button, another graphical representation, or instructions to use a specific function key) that, when selected, may cause STB 120 to present another user interface with access to recorded video from the camera currently associated with live video section 560. For example, if the user selects recordings access mechanism 576 of user interface 550 (FIG. 5C), a user interface 580 (depicted in FIG. 5D), that corresponds to the video source currently displayed in live video section 560, may be presented to the user. As shown in FIG. 5D, user interface 580 may include a navigation section 590 and a recording selection section 598.

Navigation section 590 may include selections that may permit different views and/or controls associated with security cameras. For example, navigation section 590 may include a camera selection list 592 and a return mechanism 594. Camera selection list 592 may include a list of available security cameras (e.g., for which recorded video is available). In one implementation, a user may navigate (e.g., using up arrow 320/down arrow 340 on remote control 140) to available recordings from a particular camera in camera selection list 592. When a particular (or default) camera is selected (e.g., using OK button 360), thumbnail images for recordings available from the particular camera may be presented in recording selections section 598. A user may navigate to a particular thumbnail image in recording selections section 598 and select the thumbnail image to view a larger presentation of the recording. Return mechanism 594 may include a selection mechanism that may cause STB 120 to return to a previous user interface screen (e.g., user interface 550).

Although the user interfaces in FIGS. 5A-5D depict a variety of information, in other implementations, the user interfaces may depict less information, additional information, different information, or differently arranged information than depicted in FIGS. 5A-5D.

FIG. 6 provides a diagram of exemplary operations capable of being performed by a portion 600 of the network 100 to provide live video for the camera user interface of FIGS. 5C. As shown in FIG. 6, network portion 600 may include television 110/remote control 140, STB 120, control point 130, and camera 601. Television 110, STB 120, control point 130, and remote control 140 may include the features described above in connection with one or more of, for example, FIGS. 1-4.

Camera 601 may be a particular user device 150. More particularly, camera 601 may be video camera, such as an Internet protocol (IP) camera, that can send and receive data via network 180. In one implementation, the IP camera may include built-in recording functionality to capture/store video. In another implementation, camera 601 may be managed by another device, such as control point 130 or backend server 160, to control video recordings, notifications, etc. Camera 601 may generate video in one or more particular formats, such MPEG-4.

While viewing television 110, a user may activate an interactive television application platform to control home smart appliances. Using remote control 140, the user may navigate to user interface 500 (FIG. 5A) and select camera selection mechanism 540 (FIG. 5B). By selecting camera selection mechanism 540 the user may cause remote control 140 to send a selection signal to STB 120 for a full screen video stream associated with a particular camera 601, as indicate by reference number 605. STB 120 may receive the request signal 605 and, in turn, send a request to control point 130 for an MPEG-2 video stream from the particular camera, as indicated by reference number 610. In other implementations, STB 120 may request a different video format than MPEG-2, depending on the decoding capabilities of STB 120.

Control Point 130 may receive request 610 and, in response, request a Real Time Streaming Protocol (RTSP) MPEG-4 stream from the particular camera 601, as indicated by reference number 615. In response to request 615, camera 601 may begin streaming an RTSP MPEG-4 stream 620 to control point 130. Control point 130 may receive RTSP MPEG-4 stream 620 and transcode RTSP MPEG-4 stream 620 into a format useable by STB 120. For example, control point 130 may transcode RTSP MPEG-4 stream 620 into an MPEG-2 format, as indicated by reference number 625.

After transcoding, control point 130 may make the transcoded video stream available to STB 120. In one implementation, control point 130 may broadcast the transcoded MPEG-2 stream as a user datagram protocol (UDP) unicast signal to a VOD port for STB 120, as indicated by reference number 630. Control point 130 may respond to request 610 with a success or failure message 635. For example, if control point 130 cannot successfully direct a unicast signal to the VOD port for STB 120, or if control point 130 cannot obtain a video stream from camera 601, control point 130 may provide a failure message 635 to STB 120. Conversely, if control point 130 successfully directs a unicast signal to the VOD port for STB 120, control point 130 may provide a success message 635 to STB 120. The success message may include for example, a logical channel for the UDP unicast signal.

Assuming control point 130 sends success message 635, STB 120 may receive success message 635 and tune to the IP channel at the VOD port, as indicated by reference number 640. STB 120 may then display the MPGE-2 stream on television 110. For example, STB 120 may present the MPEG-2 stream of camera 601 in live video section 560 of user interface 550 (FIG. 5C). While the user continues to view the MPEG-2 stream of camera 601, STB 120 may send periodic keep-alive messages 650 to control point 130 to prevent a timeout of the UDP streaming session.

Eventually the user may use remote control 140 to navigate away from live video section 560 of user interface 550 or to navigate to a different camera view within live video section 560, as indicated by reference number 655. STB 120 may receive the navigation command and stop transcoding/sending the video stream of camera 601, as indicated by reference number 660.

Although FIG. 6 shows example components of network portion 600, in other implementations, network portion 600 may include fewer components, different components, differently arranged components, or additional components than depicted in FIG. 6. Alternatively, or additionally, one or more components of network portion 600 may perform one or more other tasks described as being performed by one or more other components of network portion 600.

FIG. 7 provides a diagram of exemplary operations capable of being performed by an exemplary portion 700 of the network 100 to provide thumbnail videos for the camera user interface of FIGS. 5A, 5B, and 5D. As shown in FIG. 7, network portion 700 may include television 110/remote control 140, STB 120, control point 130, camera 601, and backend server 160. Television 110, STB 120, control point 130, remote control 140, backend server 160, and camera 601 may include the features described above in connection with one or more of, for example, FIGS. 1-4 and 6.

While viewing television 110, a user may activate an interactive television application platform to control home smart appliances. The user may navigate to a particular user interface that requires access to thumbnail videos, as indicated by reference number 705. For example, using remote control 140, the user may navigate to user interface 500 (FIG. 5A), user interface 580 (FIG. 5D), or another user interface that includes thumbnail videos from camera 601.

STB 120 may receive access thumbnail video request 705 and, in turn, send a request to backend server 160 for a list of available cameras, as indicated by reference number 610. Backend server 160 may receive request 710 and may, in response, send a list of camera names and/or IP addresses for available security camera(s) 601, as indicated by reference number 715.

STB 120 may receive the list of cameras and/or IP addresses and send a request 720 to control point 130 for JPEG images from camera 601. Request 720 may include, for example, a frame rate (e.g., frames per second) and count (e.g., number of frames) for a particular thumbnail video. Control Point 130 may receive request 720 and, in response, request a Motion-JPEG stream from the particular camera 601, as indicated by reference number 725.

In response to request 725, camera 601 may begin streaming motion-JPEG (MJEPG) stream 730 to control point 130. Control point 130 may receive motion-JPEG stream 730 and may transcode motion-JPEG stream 730 into a format useable by STB 120, as indicated by reference number 735. For example, control point 130 may transcode motion-JPEG stream 730 into JPEG files consistent with the frame rate and count provided in request 720.

After transcoding, control point 130 send the transcoded JPEG images to STB 120, as indicated by reference number 740. STB 120 may receive JPEG images 740 and may display the JPEG images on television 110, as indicated by reference number 745. For example, STB 120 may provide JPEG images of camera 601 at the requested frame rate and count in video thumbnail 530 of user interface 500 (FIG. 5B).

While the user continues to view the user interface with the video thumbnail, STB 120 may send periodic get JPEG images requests to control point 130, as indicated by reference number 750. For example, STB 120 may send get JPEG images request 750 when the frame count from the previous request (e.g., request 720 or a previous request 750) has been reached. In response to request 750, control point 130 may send JPEG images (e.g., transcoded from Motion-JPEG stream 730) to STB 120, as indicated by reference number 755. STB 120 may receive JPEG images 755 and may display the JPEG images on television 110, as indicated by reference number 760. For example, STB 120 may provide JPEG images of camera 601 at the requested frame rate and count in video thumbnail 530 of user interface 500 (FIG. 5B). Eventually the user may use remote control 140 to navigate away from user interface 500 or to navigate to a different camera view within user interface 500, as indicated by reference number 765. STB 120 may receive the navigation command and stop transcoding/sending the JPEG files of camera 601, as indicated by reference number 770.

Although FIG. 7 shows example components of network portion 700, in other implementations, network portion 700 may include fewer components, different components, differently arranged components, or additional components than depicted in FIG. 7. Alternatively, or additionally, one or more components of network portion 700 may perform one or more other tasks described as being performed by one or more other components of network portion 700.

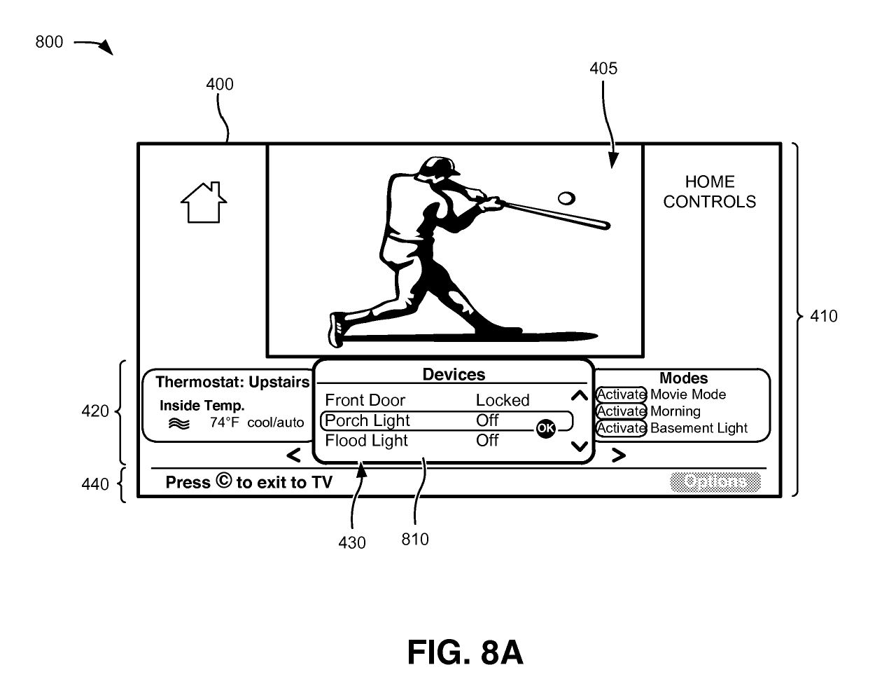

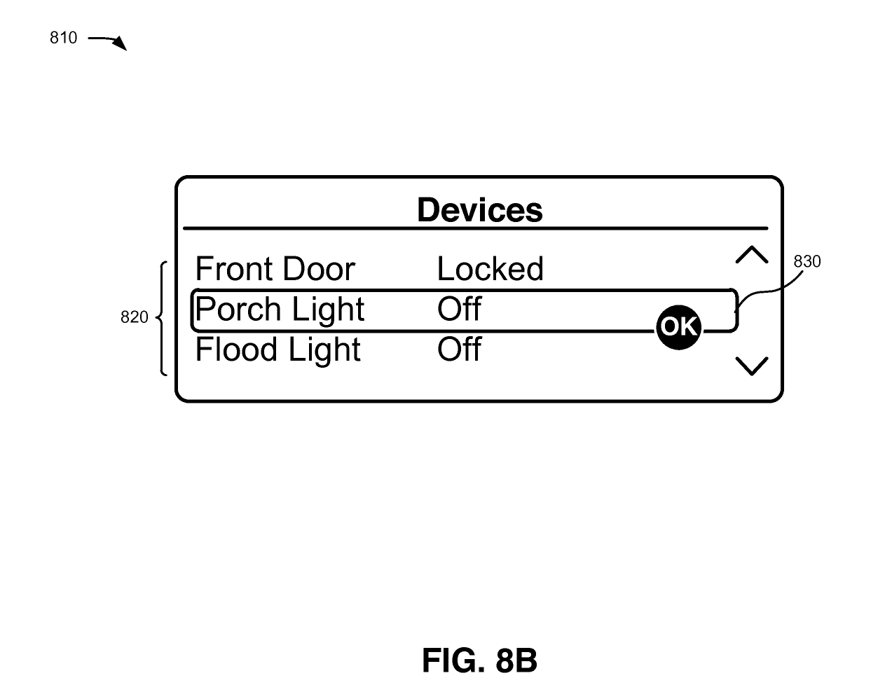

FIGS. 8A and 8B provide an exemplary user interface 800 with an active devices tile 810. As shown in FIG. 8A, to view/control home device 150 functions, a user may use remote control 140 to position devices tile 810 in the active tile frame 430 of staging area 420 within home controls frame 410. FIG. 8B provides an enlarged view of devices tile 810.

Devices tile 810 may include a list 820 of home devices 150 that may be controlled/monitored via user interface 800. The viewable size of list 820 may be limited to a small number of names or icons (e.g., associated with home devices 150) that can be accommodated with visual clarity in the size of active tile frame 430/devices tile 810. However, list 820 may include additional entries that may be viewed, for example, by using vertical scrolling commands (e.g., an up/down arrow on remote control 140, not shown). Devices tile 810 may include a selection mechanism 830 (e.g., a stage area on a scrolling list, highlights, icons, buttons, or other graphical representations) that may allow selection of a particular device item (e.g., “Porch Light”) from list 820.

A device item, when highlighted or otherwise indicated for selection via remote control 140, may be selected by an additional signal from remote control 140 (e.g., OK button 360). In one implementation, selection of the particular device item may toggle a function of a corresponding home device 150 (e.g., on/off, locked/unlocked, etc.). In another implementation, selection of the particular device item may cause STB 120 to display additional information associated with the selected home device 150. For example, selection of a particular device item from list 820 may cause STB 120 to provide a user interface that displays additional information associated with the selected home device 150 and/or allows a user to control the selected home device 150.

In one implementation, devices tile 810 may generally receive navigation/command signals from remote control 140 that include vertical indicators (e.g., up arrow 320/down arrow 340) and/or multipurpose function keys (e.g., OK button 360, “A,” “B,” etc.). Horizontal indicators (e.g., right arrow 330/left arrow 350) may be used to slide device tile 810 out of active frame tile 430 in stage area 420.

Although user interface 800 depicts a variety of information, in other implementations, user interface 800 may depict less information, additional information, different information, or differently arranged information than depicted in FIGS. 8A and 8B.

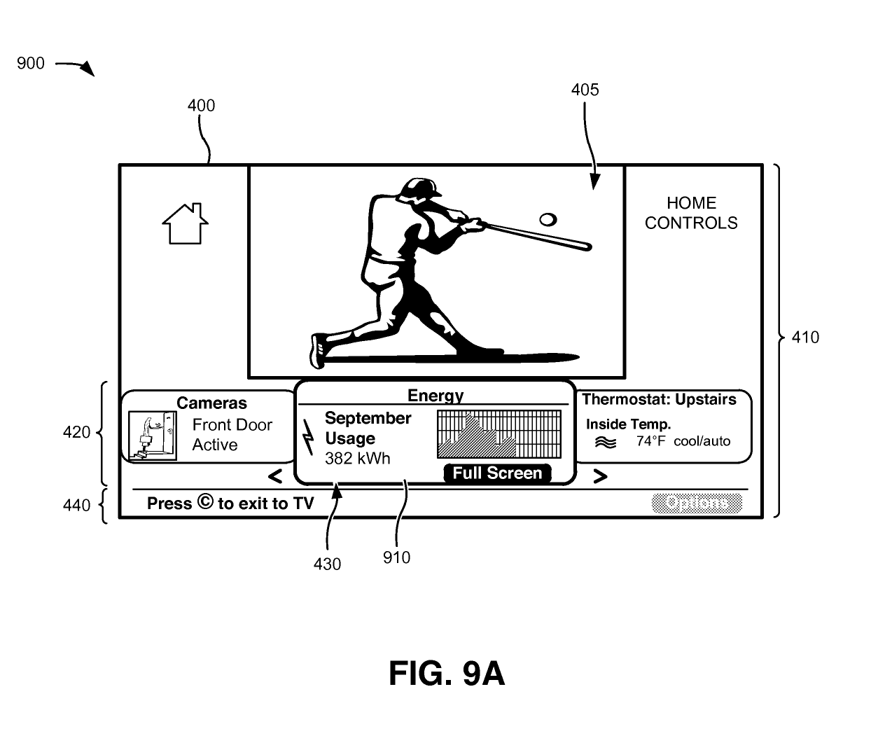

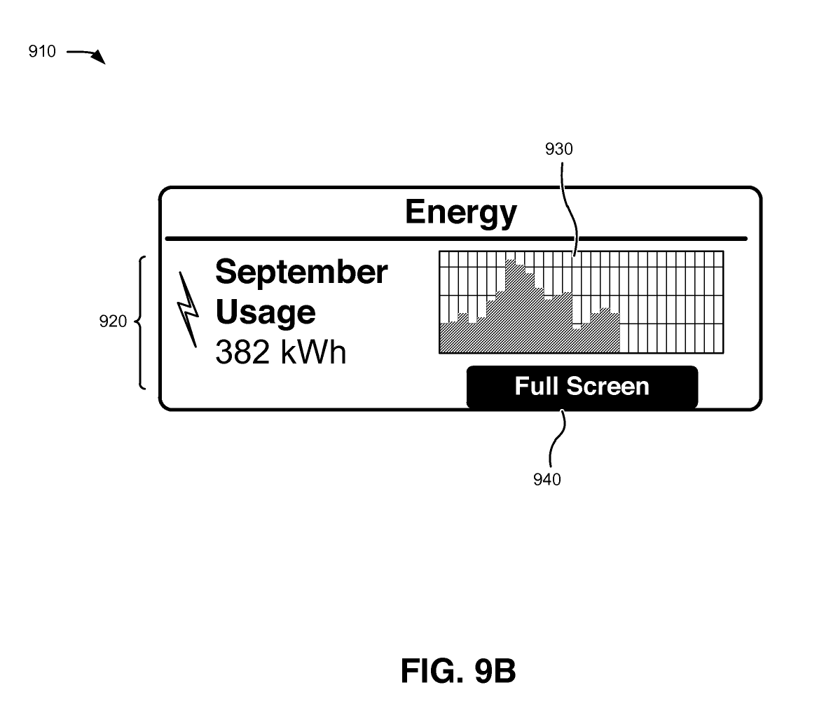

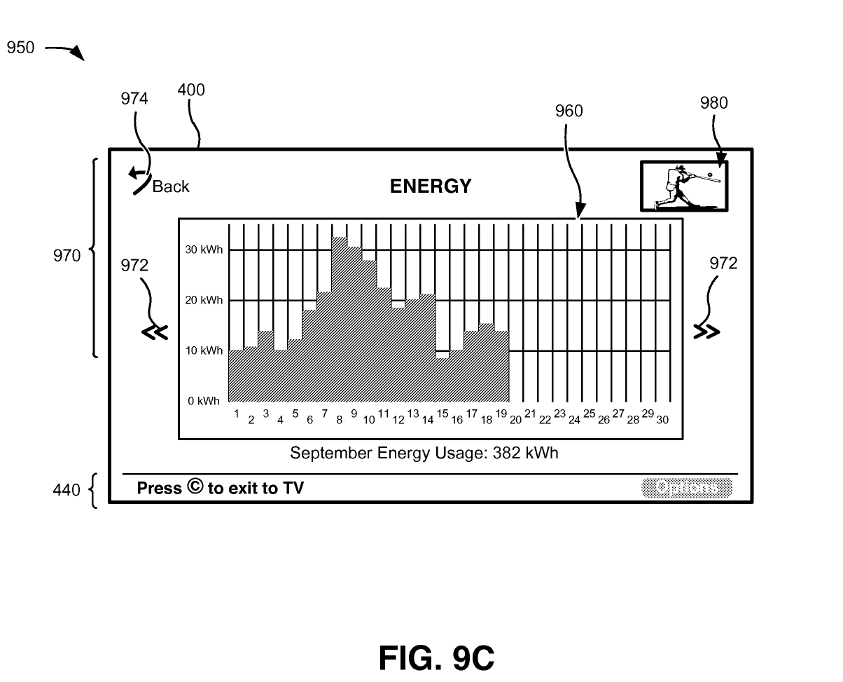

FIGS. 9A-9C provide exemplary user interfaces 900 with an active energy tile 910. As shown in FIG. 9A, to view/control energy use functions, a user may use remote control 140 to position energy tile 910 in the active tile frame 430 of staging area 420 within home controls frame 410. FIG. 9B provides an enlarged view of energy tile 910.

Energy tile 910 may include an energy use entry 920 (e.g., for home devices 150) and a graphical representation 930 associated with home energy usage. Energy use entry 920 may include, for example, a total cumulative energy consumption total for a current month (e.g., “September Usage, 482 kWh”), a current hourly energy consumption rate, or other energy use information. Graphical representation 930 may include a representation of more particular energy use. For example, graphical representation 930 may include a daily plot of energy use for the month covered in energy use entry 920.

Energy tile 910 may also include a full screen selection mechanism 940 (e.g., an icon, button, highlight, or another graphical representation) that may allow selection of a full screen user interface for energy use controls. For example, a user's selection of full screen selection mechanism 940 (e.g., “Full Screen”) may cause STB 120 to present, on television 110, a user interface 950 of FIG. 9C.

As shown in FIG. 9C, user interface 950 may include an energy use section 960, a navigation section 970, and a television viewing area 980. Energy use section 960 may include provide an indication of energy consumed by home devices 150 over a predetermined time period (e.g., a day, a week, etc.), a rate of energy consumption by home devices 150 over a predetermined time period, a cost of energy consumed by home devices 150 over a predetermined time period, etc. In one implementation, energy use section 960 may include a larger-sized version of graphical representation 930 associated with energy use entry 920.

Navigation section 970 may include selections that may permit different views and/or controls associated with home energy use. For example, navigation section 970 may include an energy information selection mechanism 972 and a return mechanism 974. Energy information selection mechanism 972 may include a selection mechanism (e.g., an icon, a button, list, another graphical representation, or instructions to use a specific function key) that, when selected, may cause energy use section 960 to present other available energy use information. For example, a home control system include separate interactive screens for that provide an indication of energy consumed by all home devices 150 over a predetermined time period (e.g., a day, a week, etc.), energy consumed by individual home devices 150 over a predetermined time period, a rate of energy consumption by home devices 150 over a predetermined time period, a cost of energy consumed by home devices 150 over a predetermined time period, etc. A user may use energy information selection mechanism 972 to toggle among the separate interactive screens. Return mechanism 974 may include a selection mechanism that may cause STB 120 to return to a previous user interface screen (e.g., user interface 900).

Television viewing area 980 may provide a reduced television viewing area (e.g., corresponding to content in television viewing area 405) to permit video/audio continuity with current television programming while user interface 950 is active.

Although user interface 900 depicts a variety of information, in other implementations, user interface 900 may depict less information, additional information, different information, or differently arranged information than depicted in FIGS. 9A-9C.

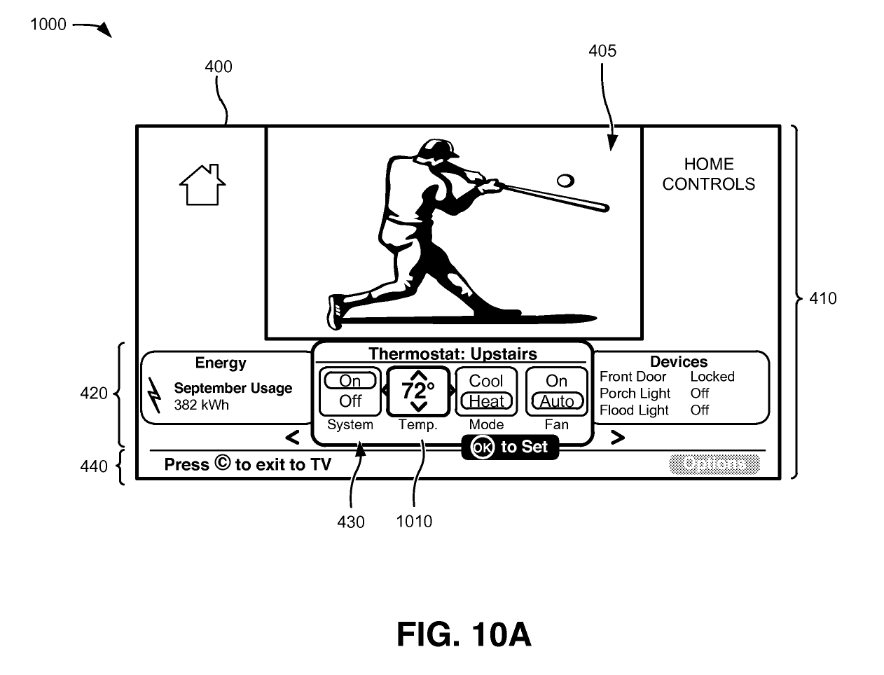

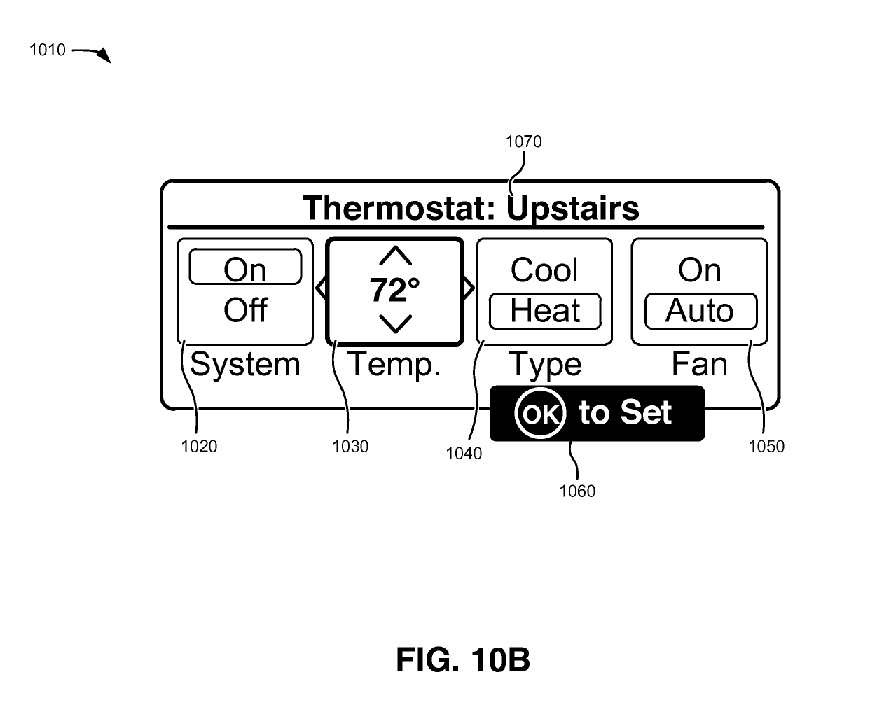

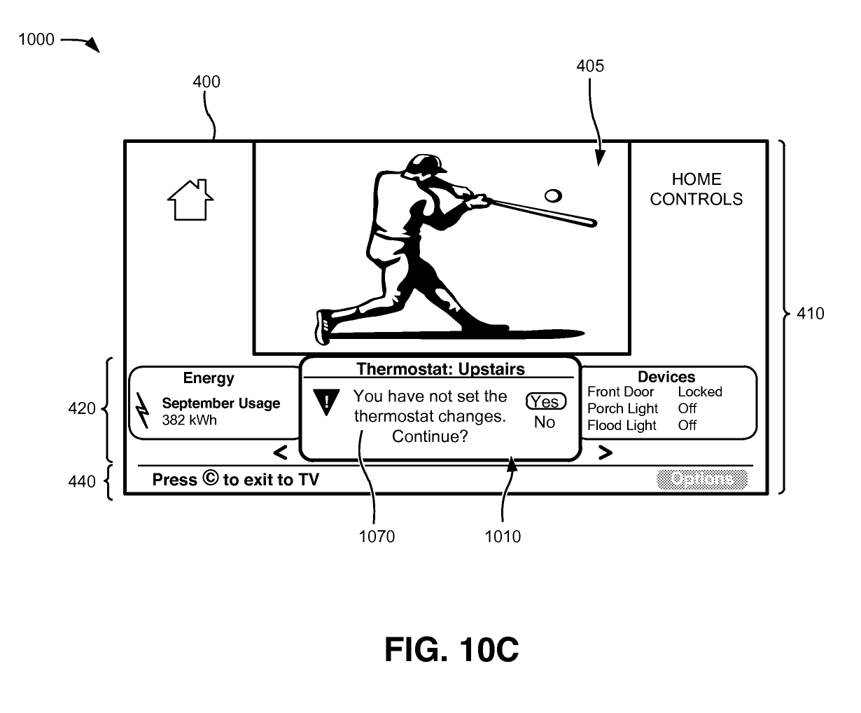

FIGS. 10A-10C provide exemplary user interfaces 1000 with an active thermostat tile 1010. As shown in FIG. 10A, to view/control thermostat functions, a user may use remote control 140 to position thermostat tile 1010 in the active tile frame 430 of staging area 420 within home controls frame 410. In one implementation, a separate thermostat tile 1010 may be used to control a single thermostat and/or zone (e.g., “Thermostat: Upstairs,” “Thermostat: Downstairs,” etc.). In another implementation, thermostat tile 1010 may include a selection mechanism (not shown) to choose among multiple thermostats/zones within a single thermostat tile 1010. FIG. 10B provides an enlarged view of thermostat tile 1010.

As shown in FIG. 10B, thermostat tile 1010 may include a system state selector 1020, a temperature control selector 1030, a type selector 1040, a fan state selector 1050, a setting activation mechanism 1060, and a system identifier 1070. System state selector 1020 may include an on/off selection for a particular thermostat (e.g., upstairs thermostat). For example, a user may use remote control 140 to provide input to toggle the thermostat on or off Temperature control selector 1030 may include a selection mechanism to view and/or adjust the temperature setting for the particular thermostat. Type selector 1040 may include a cool/heat selector for the particular thermostat. For example, a user may use remote control to toggle between an air conditioning system (e.g., “cool” and a heating system (e.g., “heat”). Fan state selector 1050 may include a selection mechanism to toggle between fan states (e.g., “on” or “auto”) the particular thermostat/zone. System identifier 1070 may provide an indication of a particular thermostats/zone when multiple thermostats/zones are available within a single thermostat tile 1010.

Setting activation mechanism 1060 may include a function to activate thermostat settings configured in system state selector 1020, temperature control selector 1030, type selector 1040, and/or fan state selector 1050. For example, changes to thermostat tile 1010 may not affect the physical system until setting activation mechanism 1060 is signaled by the user. In one implementation, thermostat tile 1010 may generally receive navigation/command signals from remote control 140 that include vertical indicators (e.g., up arrow 320/down arrow 340) and/or multipurpose function keys (e.g., OK button 360, “A,” “B,” etc.). Horizontal indicators (e.g., right arrow 330/left arrow 350) may be used to slide notifications tile 1010 out of active frame tile 430 in stage area 420.

If a user makes changes to any of system state selector 1020, temperature control selector 1030, type selector 1040, and/or fan state selector 1050 and attempts to navigate away from thermostat tile 1010 (e.g., via a horizontal indicator signal from remote control 140), notification tile 1010 may provide an alert message 1070 as shown in FIG. 10C (e.g., “You have not set the thermostat changes. Continue?”). As shown in FIG. 10C, alert message 1070 may provide a selection mechanism (e.g., “Yes”/“No”) to confirm the user's navigation away from thermostat tile 1010 without activating changes. Selecting “Yes” may allow the user to navigate to a next tile (e.g., “Energy” tile or “Devices” tile in FIG. 10C); while selecting “no” may cause STB 120 to keep thermostat tile 1010 in the active tile frame.

Although user interface 1000 depicts a variety of information, in other implementations, user interface 1000 may depict less information, additional information, different information, or differently arranged information than depicted in FIGS. 10A-10C.

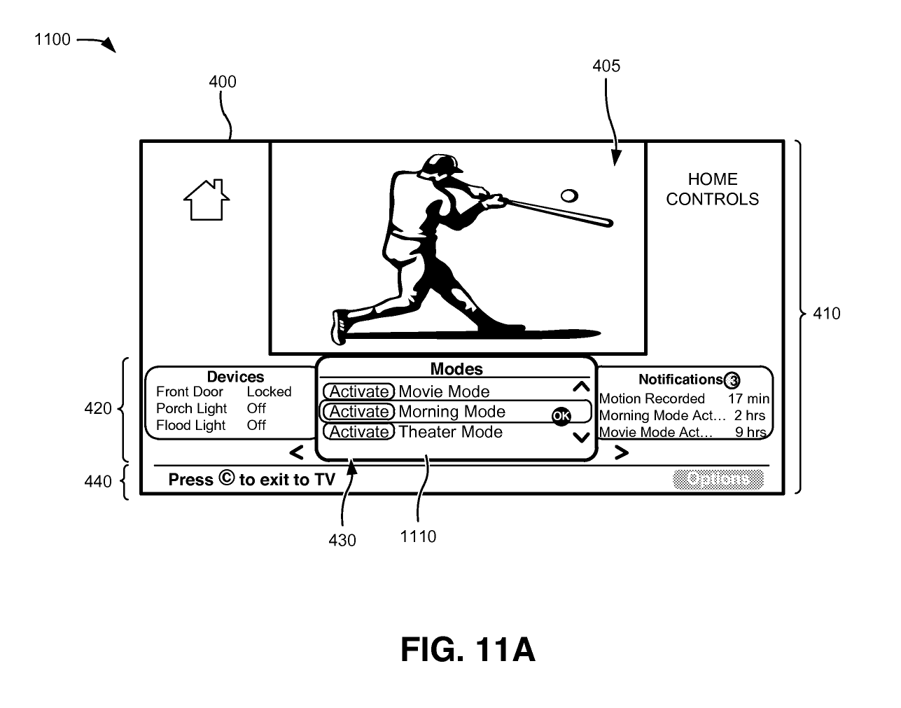

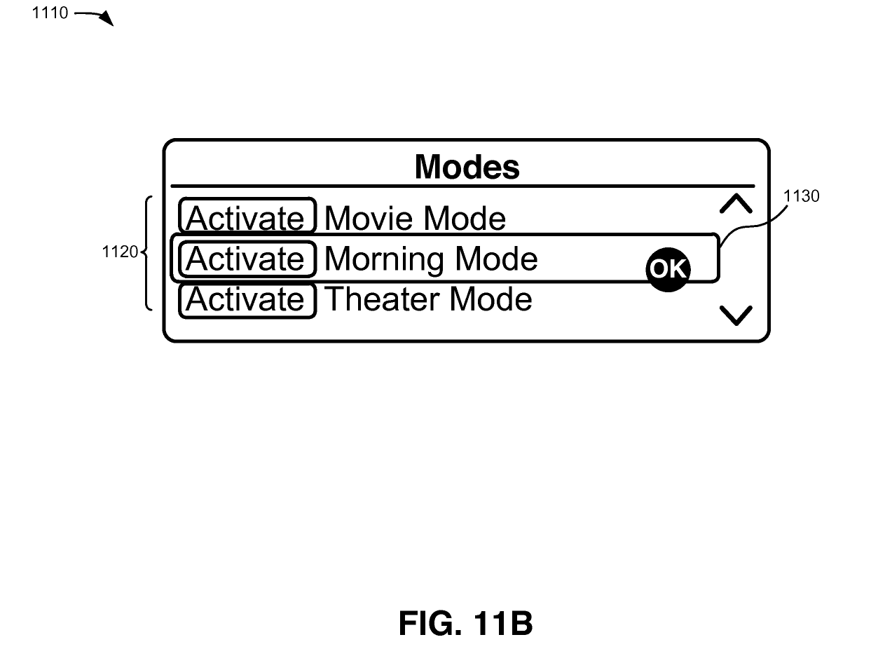

FIGS. 11A and 11B provide exemplary user interfaces 1100 with an active modes tile 1110. As shown in FIG. 11A, to view/control modes functions, a user may use remote control 140 to position modes tile 1110 in the active tile frame 430 of staging area 420 within home controls frame 410. FIG. 11B provides an enlarged view of modes tile 1110. The modes in modes tile 1110 may enable the user to control multiple home devices 150 via selection of a single mode. For example, the user interfaces depicted in FIGS. 11A and 11B may display a textual and/or graphical representation of a mode that, when selected, may instruct certain home devices 150 to perform certain functions (e.g., the morning mode may cause a security system to be deactivated, may turn off exterior lights, may unlock a front door, may start a coffee maker, etc.).

Modes tile 1110 may include a list 1120 of modes that may be controlled via user interface 1100. The viewable size of list 1120 may be limited to a small number (e.g., three or four) of mode names or icons that can be accommodated with visual clarity in the size of active tile frame 430/modes tile 1110. However, list 1120 may include additional mode names that may be viewed, for example, by using vertical scrolling commands (e.g., an up/down arrow on remote control 140, not shown). Modes tile 1110 may include a selection mechanism 1130 (e.g., a stage area on a scrolling list, highlights, icons, buttons, or other graphical representations) that may allow selection of a particular mode item (e.g., “Morning Mode”) from list 1120.

A mode item, when highlighted or otherwise indicated for selection via remote control 140, may be activated by an additional signal from remote control 140. In one implementation, selection of the particular mode item may toggle activation/deactivation of the selected mode and, thus, controlling multiple home devices 150 associated with that particular mode. In another implementation, selection of the particular mode item from list 1120 may cause STB 120 to display additional information associated with the selected mode. For example, selection of a particular mode item from list 1120 may cause STB 120 to provide a user interface that displays additional information associated with the selected mode and/or allows a user to modify settings for the selected mode.

In one implementation, modes tile 1110 may generally receive navigation/command signals from remote control 140 that include vertical indicators (e.g., up arrow 320/down arrow 340) and/or multipurpose function keys (e.g., OK button 360, “A,” “B,” etc.). Horizontal indicators (e.g., right arrow 330/left arrow 350) may be used to slide modes tile 1110 out of active frame tile 430 in stage area 420.

Although user interface 1100 depicts a variety of information, in other implementations, user interface 1100 may depict less information, additional information, different information, or differently arranged information than depicted in FIGS. 11A and 11B.

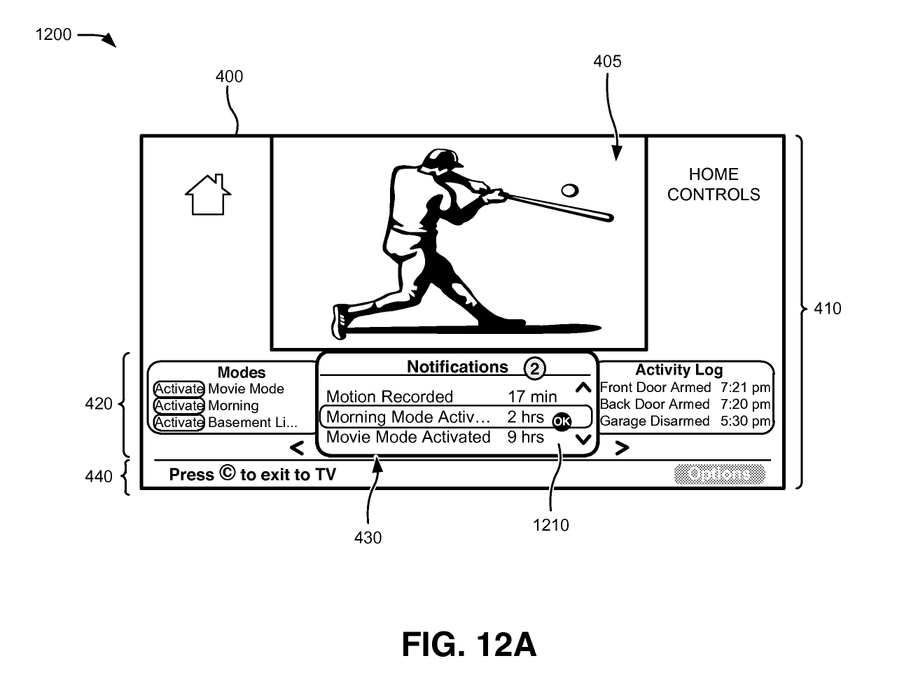

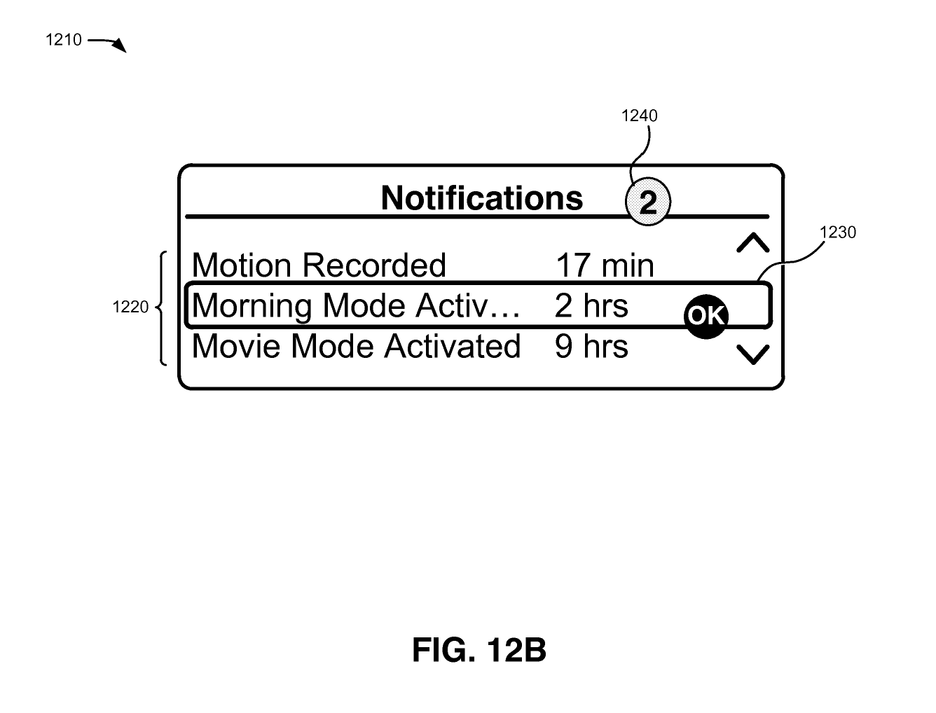

FIGS. 12A and 12B provide an exemplary user interface 1200 with an active notifications tile 1210. As shown in FIG. 12A, to view/control notifications, a user may use remote control 140 to position notifications tile 1210 in the active tile frame 430 of staging area 420 within home controls frame 410. FIG. 12B provides an enlarged view of notifications tile 1210.

Notifications tile 1210 may include a list 1220 of notifications provided by home devices 150. The viewable size of list 1220 may be limited to a small number of notifications (e.g., three or four) that can be accommodated with visual clarity in the size of active tile frame 430/notifications tile 1210. However, list 1220 may include additional entries that may be viewed, for example, by using vertical scrolling commands (e.g., an up/down arrow on remote control 140, not shown). Notifications tile 1210 may include a selection mechanism 1230 (e.g., a stage area on a scrolling list, highlights, icons, buttons, or other graphical representations) that may allow selection of a particular notification item (e.g., “Morning Mode Activated”) from list 1220.

A notification item, when highlighted or otherwise indicated for selection via remote control 140, may be selected by an additional signal from remote control 140. In one implementation, the particular selection may be briefly indicated (e.g., “OK”) before the signal causes STB 120 to display the additional information. Selection of the particular notification item from list 1220 may cause STB 120 to provide user interfaces that displays additional information associated with the selected notification and/or allow a user to control one of home devices 150 associated with the selected notification.

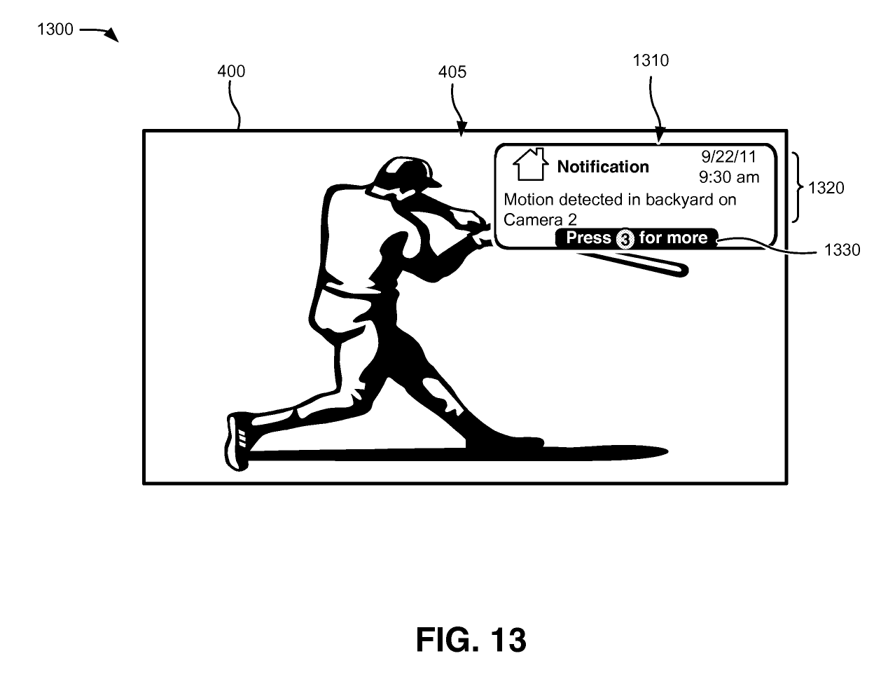

Notifications tile 1210 may also provide an indicator or badge 1240 of recent notifications. For example, indicator 1240 may provide a number of notification items from list 1220 that are new (e.g., occurring less than a certain number of minutes/hours ago and/or that have not been viewed). Alternatively, or additionally, such notifications may be provided via a pop-up window provided by STB 120, as described below in connection with FIG. 13.

In one implementation, notifications tile 1210 may generally receive navigation/command signals from remote control 140 that include vertical indicators (e.g., up arrow 320/down arrow 340) and/or multipurpose function keys (e.g., OK button 360, “A,” “B,” etc.). Horizontal indicators (e.g., right arrow 330/left arrow 350) may be used to slide notifications tile 1210 out of active frame tile 430 in stage area 420.

Although user interface 1200 depicts a variety of information, in other implementations, user interface 1200 may depict less information, additional information, different information, or differently arranged information than depicted in FIGS. 12A and 12B.

FIG. 13 provides an exemplary user interface 1300 for an automatic notification tile. User interface 1300 may automatically display information associated with notifications provided by home devices 150. For example, user interface 1300 may display mechanisms that may enable a user to view, manipulate, or control notifications associated with certain home devices 150, such as a notification (e.g., “Motion detected in backyard on Camera 2”) provided by a motion detector located in the homes back yard.

As shown in FIG. 13, notification tile 1310 may be presented within television viewing area 405 (e.g., as an overlay or picture-in-picture view). Notification tile 1310 may include notification information 1320 and a selection mechanism 1330.

Notification information 1320 may include descriptive information associated with a home device 150 (e.g., a motion detector, camera, etc.). For example, as shown in FIG. 13, notification information 1320 may indicate that motion was detected in a particular location. If the user selects selection mechanism 1330, information associated with the backyard motion detector may be provided to the user. In one implementation, for example, user selection of selection mechanism 1330 may cause STB 120 to launch home controls frame 410. In another implementation, user selection of selection mechanism 1330 may cause STB 120 to launch a full-screen user interface for a particular home device 150 associated with the notification (e.g., Camera 2). For example, assuming to the motion notification of FIG. 13, STB 120 may directly launch user interface 550 (FIG. 5C) in response to user selection of selection mechanism 1330.

Although user interface 1300 depicts a variety of information, in other implementations, user interface 1300 may depict less information, additional information, different information, or differently arranged information than depicted in FIG. 13.

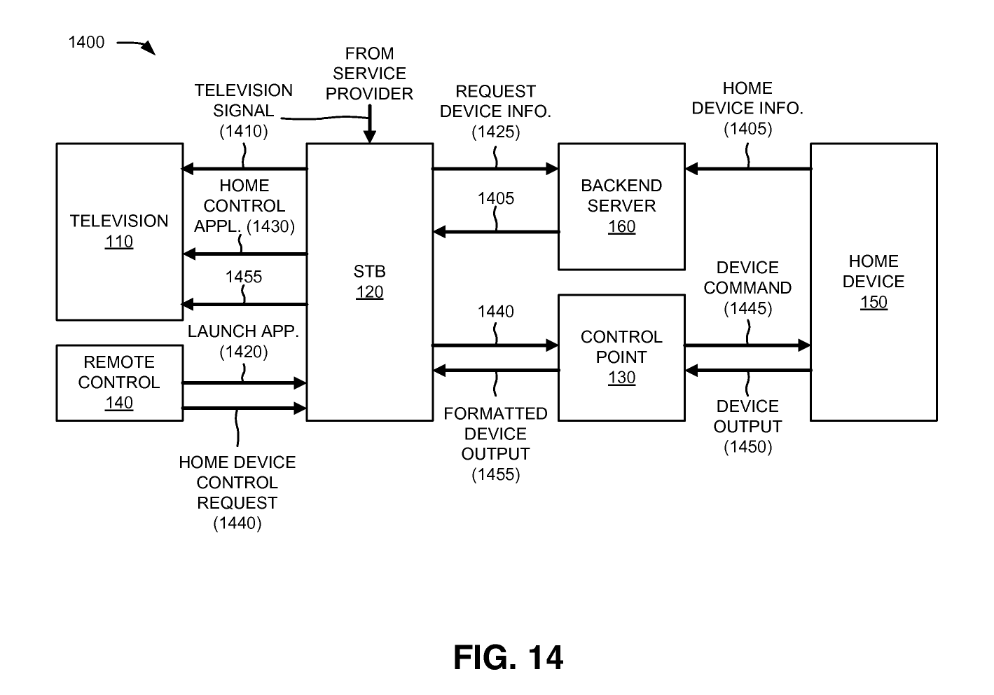

FIG. 14 is a diagram of exemplary operations capable of being performed by a portion 1400 of network 100. As shown, network portion 1400 may include television 110, STB 120, control point 130, remote control 140, home devices 150, and backend server 160. Television 110, STB 120, control point 130, remote control 140, home devices 150, and backend server 160 may include the features described above in connection with, for example, one or more of FIGS. 1-13.

As shown in FIG. 14, home devices 150 may generate and provide home device information 1405 to backend server 160. Additionally, STB 120 may receive television signals (e.g., from service provider 170) and forward the television signals to television 110 for display, as indicated by reference number 1410.

While viewing television 110, a user may use remote control 140 to launch an interactive television application platform to control home smart appliances, as indicated by reference number 1420. STB 120 may receive launch application signal 1420 and may, in turn, send a request 1425 for home device information from backend server 160. Backend server 160 may reply to STB 120 with home device information 1405. STB 120 may receive home device information 1405 and use device information 1405 to generate information for an interactive home control application, such as home control frame 410. STB 120 may provide the interactive home control application (e.g., populated with data from home device information 1405) to television 110 for presentation to the user, as indicated by reference number 1430. The interactive home control application may be presented simultaneously with television signals 1410.

A user may navigate (e.g., using remote control 140) through the interactive home control application to slide an interactive tile (e.g., one of tiles 410, 510, 810, 910, 1010, 1110, or 1210) into active tile frame 430 (e.g., as described above in connection with FIGS. 4-12) and/or select a particular function from one of the interactive tiles. The user navigation may generate a home device control request 1440 to STB 120. For example, as described above with respect to FIGS. 8A and 8B, a user may employ user interface 800 to turn a particular home device 150 on or off. As another example, as described above with respect to FIGS. 5A and 8B, a user may select an interactive tile, such as camera tile 810, that may automatically generate a request for updated video data.

STB 120 may receive home device control request 1440 and forward home device control request 1440 to control point 130. Control point may receive home device control request 1440 and may transcode/modify home device control request 1440 into a format suitable for the particular home device 150. Control point 130 may issue a device command 1445 to the particular home device 150 to implement the home control device request. For example, control point 130 may send a signal to home device 150 to turn off the home device, provide information, etc.

Home device 150 may receive device command 1445, may implement the command, and may provide device output 1450. Device output 1450 may include, for example, a notification that device command 1445 has been implemented, data requested by device command 1445, etc. Control point 130 may receive device output 1450 and may format/convert the device output into a format suitable for use by STB 120. For example, as described above in connection with FIGS. 6 and 7, control point 130 may transcode video from home device 150 (e.g., camera 601) into a format useable by STB 120. Control point may forward the modified device output to STB 120 as formatted device output 1455. STB 120 may receive formatted device output 1455 and may present formatted device output 1455 on television 110 within the home control application such that both the updated home device information the television signals may be presented concurrently.

Although FIG. 14 shows exemplary components of network portion 1400, in other implementations, network portion 1400 may contain fewer components, different components, differently arranged components, or additional components than depicted in FIG. 14. In still other implementations, one or more components of network portion 1400 may perform one or more other tasks described as being performed by one or more other components of network portion 1400.

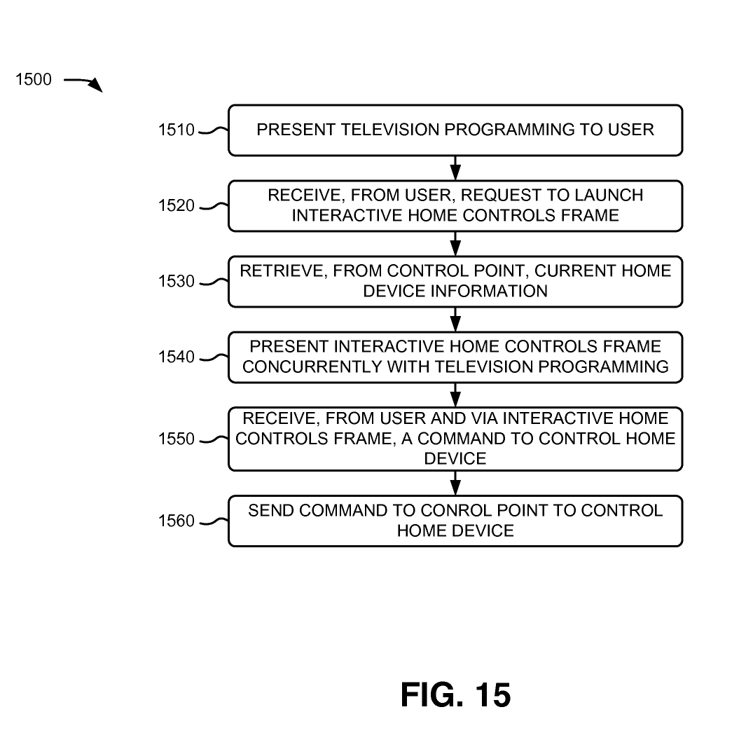

FIG. 15 is a flow chart of an exemplary process 1500 for providing smart home device management via a television interface according to implementations described herein. In one implementation, process 1500 may be performed by STB 120. In another implementation, some or all of process 1500 may be performed by another device or group of devices, including or excluding STB 120.

As shown in FIG. 15, process 1500 may include presenting television programming to a user (block 1510), and receiving, from the user, a request to launch an interactive home controls frame (block 1520). For example, in implementations described above in connection with FIG. 4, a user may view video content in television viewing area 405. Television viewing area 405 may consume the entire area of on-screen display 400 when no additional information (e.g., such as home control frame 410) is being displayed. A user may launch home controls frame 410 by using a dedicated key on remote control 140 or by selecting a home controls option from a menu (e.g., a menu of interactive application items available from STB 120).

Process 1500 may further include retrieving, from a control point, current home device information for the interactive home controls frame (block 1530), and presenting the interactive home controls frame concurrently with the television programming (block 1540). For example, STB 120 may receive formatted device output 1455 from control point 130 and may present formatted device output 1455 on television 110 within the home control application such that both the updated home device information the television signals may be presented concurrently.

Process 1500 may also include receiving, from the user and via the interactive home controls frame, a command to control a home device (block 1550), and sending to the control point the command to control the home device (block 1560). For example, a user may navigate (e.g., using remote control 140) through the interactive home control application to slide an interactive tile (e.g., one of tiles 510, 810, 910, 1010, 1110, or 1210) into active tile frame 430 (e.g., as described above in connection with FIGS. 4-12B) and/or select a particular function from one of the interactive tiles. The user navigation may generate a home device control request to STB 120. STB 120 may receive the home device control request and forward the home device control request to control point 130 for execution.

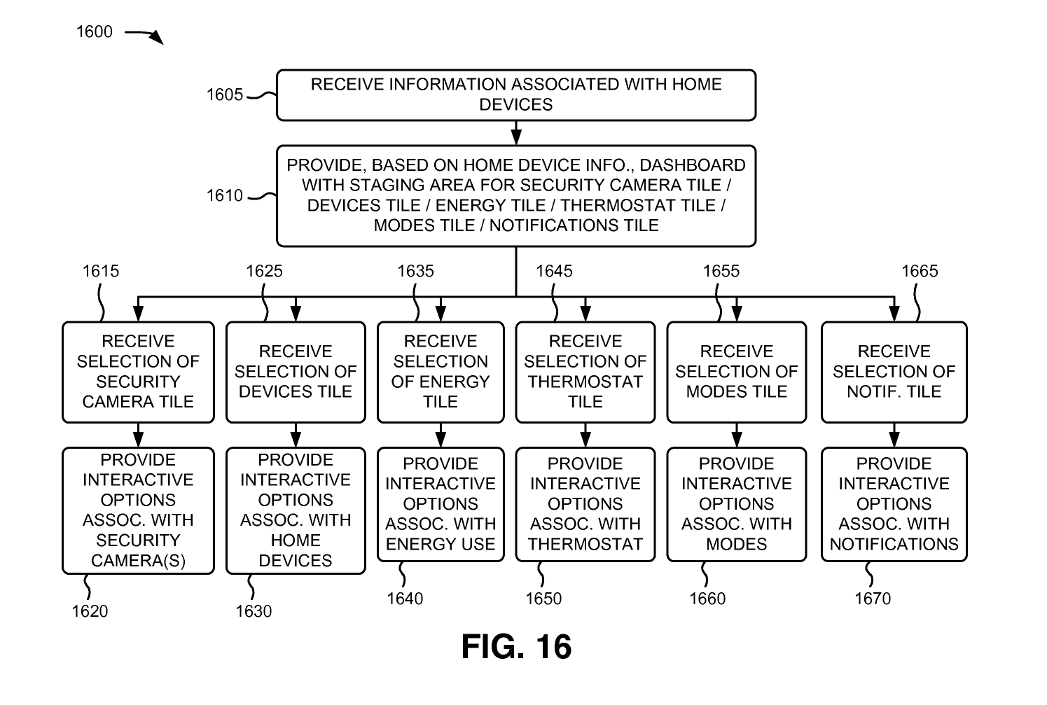

FIG. 16 is a flow chart of another exemplary process 1600 for providing smart home device management via a television interface according to implementations described herein. In one implementation, process 1600 may be performed by STB 120. In another implementation, some or all of process 1600 may be performed by another device or group of devices, including or excluding STB 120.

As illustrated in FIG. 16, process 1600 may include receiving information associated with home devices (block 1605), and providing, based on the home device information, a dashboard that includes a staging area for a security camera tile, a devices tile, an energy tile, a thermostat tile, a modes tile, or a notifications tile (block 1610). For example, in implementations described above in connection with FIGS. 4, STB 120 may receive information associated with home devices 150, and may display in staging area 420 some or all of the selectable tiles, such as a security camera tile, a devices tile, an energy tile, a thermostat tile, a modes tile, or a notifications tile. Each tile in staging area 420 may present display elements (e.g., keys, icons, buttons, links, etc.), command options, and/or information that may be unrelated to the other tiles. A user may select a particular tile via a navigation signal (e.g., a left/right arrow) on remote control 140 to position (or “slide”) a particular tile into active tile frame 430. In one implementation, only a tile and associated functions positioned within active tile frame 430 of staging area 420 may receive commands from remote control 140.

As further shown in FIG. 16, process 1600 may include receiving selection of the security camera tile (block 1615) and providing interactive options associated with the security camera(s) (block 1620). For example, in implementations described above in connection with FIG. 5A-5D, a user may use remote control 140 to position security camera tile 510 in the active tile frame 430 of staging area 420 within home controls frame 410. Security camera tile 510 may include a list of available security camera entries 520 (e.g., of home devices 150) and a thumbnail image 530 associated with each available security camera entry 520. Security camera tile 510 may generally receive navigation/command signals from remote control 140 that include vertical indicators (e.g., up arrow 320/down arrow 340) and/or multipurpose function keys (e.g., OK button 360, “A,” “B,” etc.).

As further shown in FIG. 16, process 1600 may include receiving selection of the devices tile (block 1625) and providing interactive options associated with home devices (block 1630). For example, in implementations described above in connection with FIGS. 8A and 8B, a user may use remote control 140 to position device tile 810 in the active tile frame 430 of staging area 420 within home controls frame 410. Device tile 810 may include a list 820 of home devices 150 that may be controlled/monitored via user interface 800. A device item, when highlighted or otherwise indicated for selection via remote control 140, may be selected by an additional signal from remote control 140.

Returning to FIG. 16, process 1600 may include receiving selection of the energy tile (block 1635) and providing interactive options associated with home energy use (block 1640). For example, in implementations described above in connection with FIGS. 9A-9C, to view/control energy use functions, a user may use remote control 140 to position energy tile 910 in the active tile frame 430 of staging area 420 within home controls frame 410. Energy tile 910 may include an energy use entry 920 (e.g., for home devices 150) and a graphical representation 930 associated with home energy usage. Energy tile 910 may also include a full screen selection mechanism 940 (e.g., an icon, button, highlight, or another graphical representation) that may allow selection of a full screen user interface for energy use controls.

Returning to FIG. 16, process 1600 may include receiving selection of the thermostat tile (block 1645) and providing interactive options associated with one or more thermostats (block 1650). For example, in implementations described above in connection with FIGS. 10A-10C, to view/control thermostat functions, a user may use remote control 140 to position thermostat tile 1010 in the active tile frame 430 of staging area 420 within home controls frame 410. Thermostat tile 1010 may include a system state selector 1020, a temperature control selector 1030, a type selector 1040, a fan state selector 1050, and a setting activation mechanism 1060. Changes to thermostat tile 1010 may not affect the physical system until setting activation mechanism 1060 is signaled by the user. If a user makes changes to any of system state selector 1020, temperature control selector 1030, type selector 1040, and/or fan state selector 1050 and attempts to navigate away from thermostat tile 1010 (e.g., via a horizontal indicator signal from remote control 140), notification tile 1010 may provide an alert message 1070 as shown in FIG. 10C.

As further shown in FIG. 16, process 1600 may include receiving selection of the modes tile (block 1655) and providing interactive options associated with modes (block 1660). For example, in implementations described above in connection with FIGS. 11A and 11B, to view/control modes functions, a user may use remote control 140 to position modes tile 1110 in the active tile frame 430 of staging area 420 within home controls frame 410. Modes tile 1110 may include a list 1120 of modes that may be controlled via user interface 1100. A mode item, when highlighted or otherwise indicated for selection via remote control 140, may be activated by an additional signal from remote control 140. In one implementation, selection of the particular mode item may toggle activation/deactivation of the selected mode and, thus, controlling multiple home devices 150 associated with that particular mode.

Returning to FIG. 16, process 1600 may include receiving selection of the notifications tile (block 1665) and displaying information associated with notifications provided by the home devices (block 1670). For example, in implementations described above in connection with FIGS. 12A and 12B, to view/control notifications, a user may use remote control 140 to position notifications tile 1210 in the active tile frame 430 of staging area 420 within home controls frame 410. Notifications tile 1210 may include a list 1220 of notifications provided by home devices 150. A notification item, when highlighted or otherwise indicated for selection via remote control 140, may be selected by an additional signal from remote control 140. Selection of the particular notification item from list 1220 may cause STB 120 to provide user interfaces that display additional information associated with the selected notification and/or allow a user to control one of home devices 150 associated with the selected notification.

Systems and/or methods described herein may provide management of home devices via a television interface with a remote control. The systems and/or methods may enable a user of a television to receive an overview of the home devices in an interactive user interface displayed on the television simultaneously with live television content. The interactive user interface may generally permit control of home devices via the remote control using vertical indicators (e.g., up arrow 320/down arrow 340) and/or multipurpose function keys (e.g., OK button 360, “A,” “B,” etc.). The interactive user interface may interpret horizontal indicators (e.g., right arrow 330/left arrow 350) to navigate between active tiles within the user interface.

The foregoing description of implementations provides illustration and description, but is not intended to be exhaustive or to limit the invention to the precise form disclosed. Modifications and variations are possible in light of the above teachings or may be acquired from practice of the invention.

For example, while series of blocks have been described with regard to FIGS. 15 and 16, the order of the blocks may be modified in other implementations. Further, non-dependent blocks may be performed in parallel.

It will be apparent that exemplary aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Further, certain portions of the invention may be implemented as a “component” or “logic” that performs one or more functions. These components or logic may include hardware, such as a processor, an ASIC, or a FPGA, or a combination of hardware and software.

Even though particular combinations of features are recited in the claims and/or disclosed in the specification, these combinations are not intended to limit the disclosure of the invention. In fact, many of these features may be combined in ways not specifically recited in the claims and/or disclosed in the specification. Although each dependent claim listed below may directly depend on only one other claim, the disclosure of the invention includes each dependent claim in combination with every other claim in the claim set.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method, comprising:
presenting, by a set-top box, video content on a television;
receiving, by the set-top box, a user request to present an interactive home controls application on the television;
requesting, by the set-top box and based on the user request, information associated with a plurality of home devices;
receiving, by the set-top box, the information associated with the plurality of home devices;
generating, by the set-top box and based on the home device information, an interactive home controls frame that includes a plurality of functional tiles for managing home devices; and
presenting, by the set-top box, the interactive home controls frame, including at least one of the plurality of functional tiles, and the video content on the television.

2. The method of claim 1, wherein receiving the information associated with the plurality of home devices includes:
receiving the information associated with the plurality of home devices from one of a backend server or a control point associated with the home devices.

3. The method of claim 1, further comprising:
receiving, from the user, a selection of another one of the plurality of functional tiles; and
providing, based on the home device information and within the interactive home controls frame, information associated with the selected other one of the plurality of functional tiles.

4. The method of claim 3, wherein the user selection of the one of the plurality of functional tiles is received via a signal from a remote control.

5. The method of claim 4, wherein the signal from the remote control is one of a horizontal indicator or vertical indicator to position the other one of the plurality of functional tiles within an active tile frame.

6. The method of claim 3, further comprising:
presenting, within the other one of the plurality of functional tiles, a selection mechanism to control a home device associated with the other one of the plurality of functional tiles;
receiving, from the user, a selection of the selection mechanism; and
sending, based on the user selection, a signal to a control point device to control the home device associated with the other one of the plurality of functional tiles.

7. The method of claim 6, wherein the user selection includes a vertical indicator signal from a remote control.

8. The method of claim 6, wherein the selection mechanism is for video content from a video camera, and wherein the method further comprises:
requesting, by the set-top box, an MPEG-2 stream of video content from the video camera;
retrieving, by a control point, an MPEG-4 stream from the video camera;
transcoding, by the control point, the MPEG-4 stream to an MPEG-2 stream;
sending, by the control point and to a particular port, the MPEG-2 stream;
tuning, by the set-top box, the particular port to retrieve the MPEG-2 stream; and
presenting, by the set-top box, the MPEG-2 stream on the television.

9. The method of claim 1, wherein the functional tiles include one or more of a security camera tile, a devices tile, an energy tile, a thermostat tile, a modes tile, or a notifications tile.

10. The method of claim 1, wherein the at least one of the plurality of functional tiles includes is a security camera tile that presents thumbnail images from an Internet protocol (IP) camera, and wherein the method further comprises:
requesting, by the set-top box, JPEG files from the IP camera;
retrieving, by a control point, a Motion-JPEG stream from the IP camera;
transcoding, by the control point, the Motion-JPEG stream to JPEG files;
sending, by the control point and to the set-top box, the JPEG files; and
presenting, by the set-top box, the JPEG files as a thumbnail image within the security camera tile.

11. A system, comprising:
a set-top box to:
present video content on a television,
receive a user request to present an interactive home controls application on the television,
request, based on the user request, information associated with one of a plurality of home devices,
receive, the information associated with the one of the plurality of home devices,
generate, based on the home device information, an interactive home controls frame that includes a plurality of functional tiles for managing home devices, wherein at least one of the functional tiles includes information associated with the one of the plurality of home devices, and
present the interactive home controls frame, including at least one of the plurality of functional tiles, and the video content on the television.

12. The system of claim 11, wherein the one of the plurality of home devices includes a video camera in a security system of a home.

13. The system of claim 11, wherein the plurality of functional tiles for managing home devices includes a security camera tile, a devices tile, an energy tile, a thermostat tile, a modes tile, and a notifications tile.

14. The system of claim 11, wherein the interactive home controls frame includes a stage to alternately activate one of plurality of functional tiles when one of the plurality of functional tiles is positioned within an active tile frame of the stage.

15. The system of claim 11, further comprising:
a control point device to:
receive, from the set-top box, the request for information associated with the one of the plurality of home devices,
retrieve, from the one of the plurality of home devices, data responsive to the request,
transcode the data responsive to the request, and
forward the transcoded data to the set-top box; and
a backend server to:
provide, to the set-top box, configuration information for the one of the plurality of home devices, wherein the configuration information includes an Internet protocol (IP) address.

16. A set-top box, comprising:
a memory to store a plurality of instructions; and
a processor to execute instructions in the memory to:
present video content on a television,
receive, via a remote control, a user request to present an interactive home controls application on the television,
obtain, based on the user request, information associated with at least one of a plurality of home devices,
generate, based on the information associated with the at least one of the plurality of home devices, an interactive home controls frame that includes multiple functional tiles for managing the home devices, wherein at least one of the multiple functional tiles includes information associated with the at least one of the plurality of home devices, and
present simultaneously the interactive home controls frame and the video content on the television.

17. The set-top box of claim 16, wherein, when obtaining the information associated with the at least one of the plurality of home devices, the processor is further to execute instructions in the memory to:
request the information associated with the at least one of the plurality of home devices from one of a backend server or a control point associated with the home devices.

18. The set-top box of claim 16, wherein the processor is further to execute instructions in the memory to:
receive, via the remote control, a first selection signal to select the one of the multiple functional tiles for managing the home devices, wherein the first selection signal is one of a horizontal indicator or a vertical indicator to position the one of the multiple functional tiles within an active tile frame of the interactive home controls frame,
receive, via the remote control, a second selection signal to select a particular function of a home device associated with the one of the multiple functional tiles for managing the home devices, wherein the second selection signal is one of a horizontal indicator or a vertical indicator that is different than the first selection signal, and
send to a control point, based on the second selection signal, a command to execute the particular function.

19. The set-top box of claim 16, wherein the processor is further to execute instructions in the memory to:
present, within the interactive home controls frame, one or more other of the multiple functional tiles within an inactive tile frame, wherein the multiple functional tiles within the inactive tile frame include current home device information that can be viewed and not controlled by the user.

20. The set-top box of claim 16, wherein the multiple functional tiles a security camera tile to view video output from an Internet protocol (IP) camera.
